(19) United States
(12) Patent Application Publication
(10) Pub. No.: US 2026/0236220 A1
(43) Pub. Date: Aug. 13, 2026

(54) SOUND REPRODUCTION METHOD, SOUND REPRODUCTION DEVICE, AND NON-TRANSITORY COMPUTER READABLE RECORDING MEDIUM STORING SOUND REPRODUCTION PROGRAM

(71) Applicant: PANASONIC INTELLECTUAL PROPERTY MANAGEMENT CO., LTD., Osaka (JP)

(72) Inventors: Yoshikazu HORIMOTO, Osaka (JP); Naho Kitada, Osaka (JP); Takeshi Sakai, Hyogo (JP)

(21) Appl. No.: 19/637,809

(22) Filed: Apr. 2, 2026

Related U.S. Application Data
(63) Continuation of application No. PCT/JP2024/026083, filed on Jul. 22, 2024.

(30) Foreign Application Priority Data
Oct. 4, 2023 (JP) 2023-173154

(51) Int. Cl. G06F 3/16; G06V 40/10; H04R 3/04

(52) U.S. Cl. CPC G06F 3/165; G06V 40/103; H04R 3/04; H04R 2430/01

(57) ABSTRACT

A sound reproduction device acquires information on a plurality of people in a predetermined space, synchronizes and reproduces a plurality of divided sound signals obtained by dividing a predetermined sound, and outputs, based on the information on the plurality of people, a plurality of divided sound signals to a loudspeaker that emits, to a predetermined space, a plurality of divided sounds converted from the plurality of divided sound signals.

### FIELD OF INVENTION

The present disclosure relates to a technique of reproducing sound.

### BACKGROUND ART

For example, Patent Literature 1 discloses a system for preventing eavesdropping on private conversations in a public space. In this system, a work-related or leisure group and an individual are detected. Then, in a region where there is a work-related or leisure group, volume of music is reduced, and a low frequency feature of the music is reduced. This means that people in the group can clearly hear each other's voice without the need to speak louder than sound of music, and a low frequency sound does not mask their conversation. Further, in a region where there is an individual, volume of music is increased, and a low-frequency sound (sound of running water) is added so that the individual cannot clearly hear a conversation of a work-related or leisure group.

However, in the above-described conventional technique, gathering a plurality of people in a predetermined space is not considered, and further improvement has been required.

Patent Literature 1: JP 2011-528445 A

### SUMMARY OF THE INVENTION

The present disclosure has been made to solve the above problem, and an object of the present disclosure is to provide a technique capable of gathering a plurality of people in a predetermined space and promoting a conversation of a plurality of people in a predetermined space.

A sound reproduction method according to the present disclosure is a sound reproduction method in a computer, the sound reproduction method including acquiring information on a plurality of people in a predetermined space, synchronizing and reproducing a plurality of divided sound signals obtained by dividing a predetermined sound, and outputting the plurality of divided sound signals to a loudspeaker based on the information on the plurality of people, the loudspeaker emitting, to the predetermined space, a plurality of divided sounds converted from the plurality of divided sound signals.

According to the present disclosure, a plurality of people can be gathered in a predetermined space, and a conversation of a plurality of people in the predetermined space can be promoted.

### BRIEF DESCRIPTION OF THE DRAWINGS

FIG. 1 is a diagram illustrating an overall configuration of a sound reproduction system according to a first embodiment.

FIG. 2 is a block diagram illustrating a configuration of a sound reproduction device according to the first embodiment.

FIG. 3 is a diagram illustrating an example of information stored in a personal information database in the first embodiment.

FIG. 4 is a first flowchart for explaining sound reproduction processing by the sound reproduction device according to the first embodiment of the present disclosure.

FIG. 5 is a second flowchart for explaining sound reproduction processing by the sound reproduction device according to the first embodiment of the present disclosure.

FIG. 6 is a diagram illustrating an overall configuration of the sound reproduction system according to a second embodiment.

FIG. 7 is a block diagram illustrating a configuration of the sound reproduction device according to the second embodiment.

FIG. 8 is a first flowchart for explaining sound reproduction processing by the sound reproduction device according to the second embodiment of the present disclosure.

FIG. 9 is a second flowchart for explaining sound reproduction processing by the sound reproduction device according to the second embodiment of the present disclosure.

FIG. 10 is a diagram illustrating an overall configuration of the sound reproduction system according to a third embodiment.

FIG. 11 is a block diagram illustrating a configuration of the sound reproduction device according to the third embodiment.

FIG. 12 is a first flowchart for explaining sound reproduction processing by the sound reproduction device according to the third embodiment of the present disclosure.

FIG. 13 is a second flowchart for explaining sound reproduction processing by the sound reproduction device according to the third embodiment of the present disclosure.

FIG. 14 is a diagram illustrating an overall configuration of the sound reproduction system according to a fourth embodiment.

FIG. 15 is a block diagram illustrating a configuration of the sound reproduction device according to the fourth embodiment.

FIG. 16 is a first flowchart for explaining sound reproduction processing by the sound reproduction device according to the fourth embodiment of the present disclosure.

FIG. 17 is a second flowchart for explaining sound reproduction processing by the sound reproduction device according to the fourth embodiment of the present disclosure.

### DETAILED DESCRIPTION

### Knowledge underlying present disclosure

Conventionally, how to gather a large number of people in a meeting has been a problem, and how to promote conversation of participants in a meeting has been a problem.

In Patent Literature 1 described above, in a case where there is a customer in a work-related or leisure group in a first area and there is an individual customer in a second area adjacent to the first area, volume of music in the second area is increased and a sound of running water is added to the second area. By the above, in the second area, a conversation of people in the first area is masked, and eavesdropping on a private conversation in a public place is prevented.

However, in Patent Literature 1, a person outside an area does not always want to go to the inside of the area, and it is not considered to gather a plurality of people in a predetermined space.

In order to solve the above problems, the following technique is disclosed.

(1) A sound reproduction method according to one aspect of the present disclosure is a sound reproduction method in a computer, the sound reproduction method including acquiring information on a plurality of people in a predetermined space, synchronizing and reproducing a plurality of divided sound signals obtained by dividing a predetermined sound, and outputting the plurality of divided sound signals to a loudspeaker based on the information on the plurality of people, the loudspeaker emitting, to the predetermined space, a plurality of divided sounds converted from the plurality of divided sound signals.

According to this configuration, a plurality of divided sound signals synchronized and reproduced are output to the loudspeaker based on information on a plurality of people, and a plurality of divided sounds are emitted from the loudspeaker in a predetermined space.

Therefore, when a plurality of people gather, a plurality of divided sounds overlap each other in a predetermined space, and one harmonious sound is heard. Therefore, a plurality of people can be gathered in the predetermined space, and a conversation of a plurality of people in the predetermined space can be promoted.

(2) In the sound reproduction method according to (1) above, the information on the plurality of people may include identification result information that identifies each of the plurality of people, and the sound reproduction method may further include controlling volume of each of the plurality of divided sound signals according to whether or not each of the plurality of people is identified.

According to this configuration, volume of each of a plurality of divided sound signals is controlled according to whether or not each of a plurality of people is in a predetermined space. Therefore, in a case where a plurality of people are in a predetermined space, a predetermined sound obtained by superimposing a plurality of divided sounds can be output into the predetermined space.

(3) In the sound reproduction method according to (2) above, the control of volume may include determining volume of a divided sound signal associated with a person to be a predetermined volume in a case where the person is identified, and determining the volume of the divided sound signal associated with the person to be zero in a case where the person is not identified.

According to this configuration, volume of a divided sound signal is controlled such that a divided sound associated with a person is not output in a case where the person is not in a predetermined space, and the divided sound associated with the person is output in a case where the person is in the predetermined space. Therefore, as the number of people in a predetermined space increases, the predetermined space becomes a space with a pleasant atmosphere in which many divided sounds overlap, and thus a plurality of people can be gathered in the predetermined space.

(4) In the sound reproduction method according to (1) above, the information on the plurality of people may include voice information indicating an average volume of voice of each of the plurality of people in a predetermined period, and the sound reproduction method may further include controlling volume of each of the plurality of divided sound signals according to the average volume of the voice of each of the plurality of people in the predetermined period.

According to this configuration, volume of each of a plurality of divided sound signals is controlled according to an average volume of voice of each of a plurality of people in a predetermined period. Therefore, volume of a divided sound can be changed according to whether or not a person is speaking, and a person who is not speaking can be prompted to speak according to the presence or absence of a divided sound in the predetermined space.

(5) In the sound reproduction method according to (4) above, the control of the volume may include determining volume of a divided sound signal associated with a person to be a predetermined volume in a case where the average volume of voice of the person is smaller than a threshold, and determining the volume of the divided sound signal associated with the person to be zero in a case where the average volume of the voice of the person is equal to or more than the threshold.

According to this configuration, in a case where an amount of speech of a person is small, a divided sound associated with the person is output, and in a case where the amount of speech of the person is large, the divided sound associated with the person is not output, and therefore, a person with a small amount of speech can be prompted to speak.

(6) In the sound reproduction method according to (1) above, the information on the plurality of people may include posture information on a posture of each of the plurality of people, and the sound reproduction method may further include controlling volume of each of the plurality of divided sound signals according to the posture of each of the plurality of people.

According to this configuration, volume of each of a plurality of divided sound signals is controlled according to a posture of each of a plurality of people. Therefore, it is possible to determine whether or not to emit each of the plurality of divided sounds from the loudspeaker according to a posture of each of the plurality of people.

(7) In the sound reproduction method according to (6) above, the posture information may indicate whether or not each of the plurality of people is standing, and the control of the volume may include determining volume of a divided sound signal to be a predetermined volume in a case where a person is standing, and determining the volume of the divided sound signal to be zero in a case where the person is not standing.

According to this configuration, when a plurality of people are standing, a plurality of divided sounds are output, so that it is possible to make the inside of a predetermined space an environment in which a plurality of people can easily gather. Further, when a plurality of people are sitting, a plurality of divided sounds are not output, so that it is possible to make the inside of a predetermined space an environment in which a plurality of people can easily have a conversation.

(8) In the sound reproduction method according to (7) above, each of the plurality of divided sound signals may be associated with each of a plurality of positions at which the plurality of people are present in the predetermined space.

According to this configuration, a divided sound associated with a position at which a person is present in a predetermined space can be emitted from the loudspeaker.

(9) In the sound reproduction method according to (6) above, the posture information may indicate whether or not each of the plurality of people is sitting at each of a plurality of positions in the predetermined space, and indicate whether or not at least one of the plurality of people is in a posture of feeling drowsy, and the control of the volume may include determining volume of a divided sound signal associated with a position at which a person is sitting to be a predetermined volume in a case where the person is sitting, determining the volume of the divided sound signal associated with a position at which the person is not sitting to be zero in a case where the person is not sitting, determining, in a case where at least one of the plurality of people is in a posture of feeling drowsy, volume of a different divided sound signal for suppressing the drowsiness different from the plurality of divided sound signals associated with each of the plurality of positions to be a predetermined volume, and determining the volume of the different divided sound signal to be zero in a case where all of the plurality of people are not in a posture of feeling drowsy.

According to this configuration, in a case where there is a person who is feeling drowsy in a predetermined space, another divided sound for suppressing the drowsiness is output, so that it is possible to provide a stimulus to the person who is feeling drowsy and cause the person to focus on a conversation.

(10) In the sound reproduction method according to any one of (1) to (9) above, the predetermined sound may be divided according to frequency.

According to this configuration, it is possible to cause a plurality of divided sound signals at a plurality of frequency bands to be emitted in a predetermined area, and it is possible to cause one harmonious sound to be emitted by overlapping a plurality of divided sounds.

(11) In the sound reproduction method according to any one of (1) to (9) above, the predetermined sound may be music, and may be divided according to a plurality of performance parts forming the music.

According to this configuration, a plurality of divided sounds for a plurality of performance parts forming music can be emitted in a predetermined space, and one piece of harmonious music can be emitted by overlapping the plurality of divided sounds.

The present disclosure can be implemented not only as a sound reproduction method for executing the characteristic processing as described above, but also as a sound reproduction device or the like having a characteristic configuration corresponding to characteristic processing executed by the sound reproduction method. Further, the present disclosure can also be implemented as a computer program that causes a computer to execute characteristic processing included in the sound reproduction method described above. Therefore, an effect similar to the effect in the above sound reproduction method can also be achieved by another aspect described below.

(12) A sound reproduction device according to another aspect of the present disclosure includes an acquisition part that acquires information on a plurality of people in a predetermined space, a reproduction part that synchronizes and reproduces a plurality of divided sound signals obtained by dividing a predetermined sound, and an output part that outputs the plurality of divided sound signals to a loudspeaker based on the information on the plurality of people, the loudspeaker emitting, to the predetermined space, a plurality of divided sounds converted from the plurality of divided sound signals.

(13) A sound reproduction program according to another aspect of the present disclosure causes a computer to function to acquire information on a plurality of people in a predetermined space, synchronize and reproduce a plurality of divided sound signals obtained by dividing a predetermined sound, and output the plurality of divided sound signals to a loudspeaker based on the information on the plurality of people, the loudspeaker emitting, to the predetermined space, a plurality of divided sounds converted from the plurality of divided sound signals.

(14) A non-transitory computer-readable recording medium according to another aspect of the present disclosure records a sound reproduction program, and the sound reproduction program causes a computer to function to acquire information on a plurality of people in a predetermined space, synchronize and reproduce a plurality of divided sound signals obtained by dividing a predetermined sound, and output the plurality of divided sound signals to a loudspeaker based on the information on the plurality of people, the loudspeaker emitting, to the predetermined space, a plurality of divided sounds converted from the plurality of divided sound signals.

Hereinafter, embodiments of the present disclosure will be described with reference to the accompanying drawings. Note that each of the embodiments described below illustrates a specific example of the present disclosure. Numerical values, shapes, components, steps, order of steps, and the like of the embodiments below are merely examples, and are not intended to limit the present disclosure. Further, a component not described in an independent claim representing a highest concept among components in the embodiments below is described as an optional component. Further, in all the embodiments, pieces of content can be combined.

### First embodiment

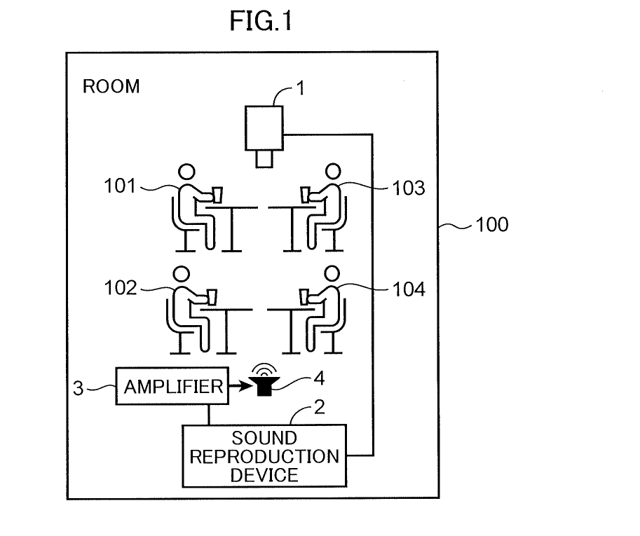

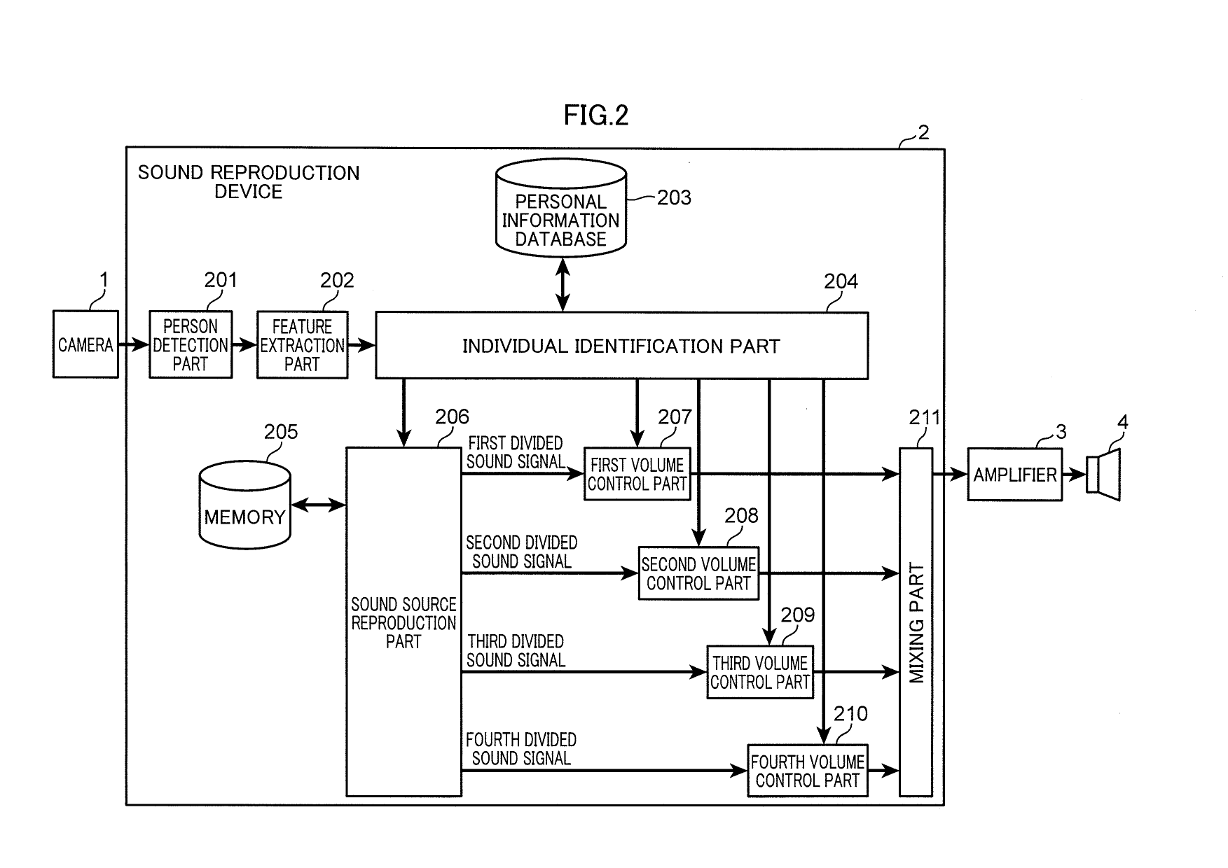

FIG. 1 is a diagram illustrating an overall configuration of a sound reproduction system according to a first embodiment, and FIG. 2 is a block diagram illustrating a configuration of a sound reproduction device 2 according to the first embodiment.

The sound reproduction system includes a camera 1, a sound reproduction device 2, an amplifier 3, and a loudspeaker 4.

The camera 1 captures an image of a predetermined space. The camera 1 is a fixed camera such as a monitoring camera, and is disposed at a position where an image of an entire predetermined space can be captured. The predetermined space is, for example, a room 100 such as a conference room in which a plurality of people (a first person 101, a second person 102, a third person 103, and a fourth person 104) can gather. In the first embodiment, the camera 1 captures an image of the inside of the room 100. Further, the sound reproduction system may include the single camera 1 or a plurality of the cameras 1.

For example, in the room 100, a meeting is held by the first person 101, the second person 102, the third person 103, and the fourth person 104. The meeting is a meeting in which each person proposes various ideas. As music is played during the meeting, the room 100 becomes a space with a pleasant atmosphere, and conversation of participants of the meeting is promoted.

The camera 1 is connected to the sound reproduction device 2 itself or a hub (not illustrated) such as a communication device or a server in a wired or wireless manner so that a captured image can be input to the sound reproduction device 2. The camera 1 may be communicably connected to the sound reproduction device 2 via a network. The camera 1 outputs a captured image to the sound reproduction device 2.

Note that an image captured by the camera 1 may be output in real time, or after the image is once recorded in an external storage device such as a memory or a cloud server, the image may be output from the external storage device.

The sound reproduction device 2 acquires information on a plurality of people in a predetermined space, synchronizes and reproduces a plurality of divided sound signals obtained by dividing a predetermined sound, and outputs, based on the information on the plurality of people, a plurality of divided sound signals to the loudspeaker 4 that emits, to the predetermined space, a plurality of divided sounds converted from the plurality of divided sound signals.

The sound reproduction device 2 detects a plurality of people (the first person 101, the second person 102, the third person 103, and the fourth person 104) present in a predetermined space (the room 100) based on an image captured by the camera 1. The sound reproduction device 2 identifies each of a plurality of people (the first person 101, the second person 102, the third person 103, and the fourth person 104), and controls volume of each of a plurality of divided sound signals according to whether or not each of the plurality of people (the first person 101, the second person 102, the third person 103, and the fourth person 104) is identified. That is, the sound reproduction device 2 changes volume of each of a first divided sound signal to a fourth divided sound signal according to whether or not each of a plurality of people (the first person 101, the second person 102, the third person 103, and the fourth person 104) is present in a predetermined space (the room 100).

The sound reproduction device 2 includes at least a computer system including, for example, a control program, a processing circuit such as a processor or a logic circuit that executes the control program, and a recording device such as an internal memory or an accessible external memory that stores the control program. Note that the sound reproduction device 2 may be implemented by, for example, hardware implementation by a processing circuit, execution of a software program held in a memory by a processing circuit or distributed from an external server, or a combination of these hardware implementation and software implementation.

The sound reproduction device 2 includes a person detection part 201, a feature extraction part 202, a personal information database 203, an individual identification part 204, a memory 205, a sound source reproduction part 206, a first volume control part 207, a second volume control part 208, a third volume control part 209, a fourth volume control part 210, and a mixing part 211.

The person detection part 201 detects a person in the room 100 based on an image captured by the camera 1.

The feature extraction part 202 extracts a feature amount of a face of a person detected by the person detection part 201.

The personal information database 203 stores feature amounts of faces of a plurality of people and identification information (user IDs) for identifying the plurality of people in association with each other. Here, a method of registering a feature amount of a face of a person in the personal information database 203 will be described. First, an image of a person is captured by a camera. Next, a person is detected from the captured image, and a feature amount of the face of the detected person is extracted. Next, identification information of the person is input by an input device such as a touch panel. Next, the feature amount of the face of the person and the identification information of the person are stored in association with each other in the personal information database 203.

Further, the personal information database 203 stores identification information for identifying a plurality of people and preferred musical instruments of the plurality of people in association with each other.

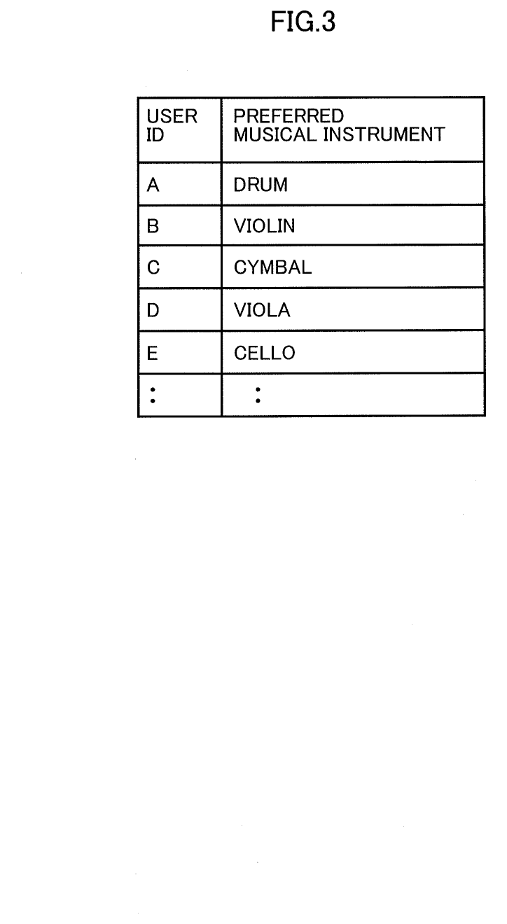

FIG. 3 is a diagram illustrating an example of information stored in the personal information database 203 in the first embodiment.

As illustrated in FIG. 3, a preferred musical instrument of each person is associated with a user ID (identification information). For example, a musical instrument “drum” is associated with a user ID “A”. Note that the sound reproduction device 2 may receive input of a user ID and a preferred musical instrument by a person, and store the received user ID and preferred musical instrument in association with each other in the personal information database 203. Note that at least a feature amount of a face of a person and identification information of the person only need to be stored in association with each other in the personal information database 203, and a preferred musical instrument does not need to be registered.

The individual identification part 204 outputs a reproduction start instruction for starting reproduction of a predetermined sound to the sound source reproduction part 206. In a case where a person is detected by the person detection part 201, the individual identification part 204 outputs a reproduction start instruction to the sound source reproduction part 206. Further, in a case where a person is no longer detected by the person detection part 201, the individual identification part 204 may output a reproduction end instruction for ending reproduction of a predetermined sound to the sound source reproduction part 206. Further, in a case where one of a plurality of people is identified, the individual identification part 204 may output a reproduction start instruction to the sound source reproduction part 206.

Further, the individual identification part 204 may select a sound corresponding to a current time period from among a plurality of sounds of different types, and output a reproduction start instruction for starting reproduction of the selected sound to the sound source reproduction part 206. For example, the individual identification part 204 may select a sound corresponding to a current time period from among a first sound corresponding to a time period in the morning (8:00 AM to 12:00 PM), a second sound corresponding to a time period in the afternoon (12:00 PM to 6:00 PM), and a third sound corresponding to a time period in the night (6:00 PM to 10:00 PM). Note that the time period is not limited to the above.

The individual identification part 204 acquires information on a plurality of people in a predetermined space. The individual identification part 204 identifies each of a plurality of people present in a predetermined space. The individual identification part 204 controls volume of each of a plurality of divided sound signals according to whether or not each of a plurality of people is identified.

The individual identification part 204 compares a feature amount of a face extracted by the feature extraction part 202 with each of feature amounts of faces of a plurality of people stored in the personal information database 203. When there is a feature amount that matches a feature amount of a face extracted by the feature extraction part 202 among feature amounts of faces of a plurality of people stored in the personal information database 203, the individual identification part 204 reads identification information associated with the feature amount from the personal information database 203 and identifies a person from the read identification information.

A plurality of people and a plurality of divided sound signals are associated with each other in advance. The individual identification part 204 refers to the personal information database 203, extracts a preferred musical instrument corresponding to a user ID of the identified person, and associates, as a divided sound signal of the person, a divided sound signal corresponding to the extracted preferred musical instrument among a plurality of divided sound signals.

Note that, in a case where a preferred musical instrument corresponding to a user ID of the identified person is not registered in the personal information database 203, the individual identification part 204 may associate, as a divided sound signal of the person, any one divided sound signal other than a divided sound signal already associated as a divided sound signal of any person among a plurality of divided sound signals.

The individual identification part 204 determines volume of the first divided sound signal associated with the first person 101 according to whether or not the first person 101 is present in the room 100, and sends an instruction to the first volume control part 207 indicating the determined volume. The individual identification part 204 determines volume of the second divided sound signal associated with the second person 102 according to whether or not the second person 102 is present in the room 100, and sends an instruction to the second volume control part 208 indicating the determined volume. The individual identification part 204 determines volume of the third divided sound signal associated with the third person 103 according to whether or not the third person 103 is present in the room 100, and sends an instruction to the third volume control part 209 indicating the determined volume. The individual identification part 204 determines volume of the fourth divided sound signal associated with the fourth person 104 according to whether or not the fourth person 104 is present in the room 100, and sends an instruction to the fourth volume control part 210 indicating the determined volume.

In a case where a person is identified, the individual identification part 204 determines volume of a divided sound signal associated with the person to be a predetermined volume. The predetermined volume is, for example, maximum volume. In a case where no person is identified, the individual identification part 204 determines volume of a divided sound signal associated with a person to be zero. Note that, the predetermined volume is not limited to maximum volume, and may be 50% or 80% of maximum volume, and only needs to be larger than 0.

In a case where the first person 101 is identified in the room 100, the individual identification part 204 determines volume of the first divided sound signal associated with the first person 101 to be a predetermined volume. Further, in a case where the first person 101 is not identified in the room 100, the individual identification part 204 determines volume of the first divided sound signal associated with the first person 101 to be zero.

In a case where the second person 102 is identified in the room 100, the individual identification part 204 determines volume of the second divided sound signal associated with the second person 102 to be a predetermined volume. Further, in a case where the second person 102 is not identified in the room 100, the individual identification part 204 determines volume of the second divided sound signal associated with the second person 102 to be zero.

In a case where the third person 103 is identified in the room 100, the individual identification part 204 determines volume of the third divided sound signal associated with the third person 103 to be a predetermined volume. Further, in a case where the third person 103 is not identified in the room 100, the individual identification part 204 determines volume of the third divided sound signal associated with the third person 103 to be zero.

In a case where the fourth person 104 is identified in the room 100, the individual identification part 204 determines volume of the fourth divided sound signal associated with the fourth person 104 to be a predetermined volume. Further, in a case where the fourth person 104 is not identified in the room 100, the individual identification part 204 determines volume of the fourth divided sound signal associated with the fourth person 104 to be zero.

Note that, in the first embodiment, the number of a plurality of people is four, but the present disclosure is not particularly limited to this, and the number of a plurality of people may be two or more.

The memory 205 stores in advance a plurality of divided sound signals obtained by dividing a predetermined sound. The memory 205 stores in advance the first divided sound signal, the second divided sound signal, the third divided sound signal, and the fourth divided sound signal. Note that the memory 205 may store a plurality of sounds in advance. The number of a plurality of divided sound signals may be the same as or different from the number of a plurality of people.

The predetermined sound is, for example, a series of musical pieces by performance of a plurality of musical instruments. Note that the predetermined sound is not limited to music as long as the predetermined sound is a series of audio contents, and, for example, the predetermined sound may be a series of natural sounds including a plurality of sounds such as a wind sound, a sound of running water, a chirping sound of an insect, or a chirping sound of a bird.

Further, the predetermined sound may be divided according to a performance part of music to be reproduced. For example, the predetermined sound may be divided into the first divided sound signal representing a melody part playing a main melody, the second divided sound signal representing a harmony part playing a chord or a secondary melody for the melody part, the third divided sound signal representing a rhythm part responsible for a rhythm of music, and the fourth divided sound signal representing a bass part responsible for a low frequency range.

The predetermined sound may be divided according to a type of musical instrument to be played. For example, the predetermined sound may be divided into the first divided sound signal representing a drum sound, the second divided sound signal representing a bass sound, the third divided sound signal representing a keyboard sound, and the fourth divided sound signal representing a guitar sound.

Furthermore, the predetermined sound may be divided according to frequency. For example, the predetermined sound may be divided into the first divided sound signal at a frequency of 50 Hz or less, the second divided sound signal at a frequency between 50 Hz and 500 Hz, the third divided sound signal at a frequency between 500 Hz and 1 kHz, and the fourth divided sound signal at a frequency of 1 kHz or more.

Further, the predetermined sound may be divided according to a plurality of elements constituting the predetermined sound. For example, in a case where the predetermined sound is a series of natural sounds, the predetermined sound may be divided into the first divided sound signal representing a wind sound, the second divided sound signal representing a sound of running water, the third divided sound signal representing a chirping sound of an insect, and the fourth divided sound signal representing a chirping sound of a bird.

The sound source reproduction part 206 synchronizes and reproduces a plurality of divided sound signals obtained by dividing a predetermined sound. The sound source reproduction part 206 is an example of a reproduction part. The sound source reproduction part 206 reads a plurality of divided sound signals from the memory 205. When a reproduction start instruction is input from the individual identification part 204, the sound source reproduction part 206 starts reproduction of a plurality of divided sound signals obtained by dividing the predetermined sound. Furthermore, when a reproduction end instruction is input from the individual identification part 204, the sound source reproduction part 206 ends reproduction of a plurality of divided sound signals obtained by dividing the predetermined sound.

The sound source reproduction part 206 synchronizes and reproduces all of the first divided sound signal to the fourth divided sound signal regardless of whether or not the first person 101 to the fourth person 104 are present in the room 100. That is, when at least one of the first person 101 to the fourth person 104 is in the room 100, the sound source reproduction part 206 synchronizes and reproduces all of the first divided sound signal to the fourth divided sound signal.

The sound source reproduction part 206 outputs the first divided sound signal to the first volume control part 207, outputs the second divided sound signal to the second volume control part 208, outputs the third divided sound signal to the third volume control part 209, and outputs the fourth divided sound signal to the fourth volume control part 210.

The first volume control part 207 to the fourth volume control part 210 output a plurality of divided sound signals reproduced by the sound source reproduction part 206 to the loudspeaker 4 that emits a plurality of divided sounds converted from a plurality of divided sound signals to a predetermined space (the room 100). The first volume control part 207 to the fourth volume control part 210 are examples of an output part. Further, the first volume control part 207 to the fourth volume control part 210 control volume of each of a plurality of divided sound signals according to whether or not each of a plurality of people is present in a predetermined space.

The first volume control part 207 controls volume of the first divided sound signal according to an identification result of the first person 101. That is, the first volume control part 207 controls volume of the first divided sound signal according to whether or not the first person 101 is present in the room 100. The first volume control part 207 sets volume of the first divided sound signal input from the sound source reproduction part 206 to volume instructed by the individual identification part 204.

The second volume control part 208 controls volume of the second divided sound signal according to an identification result of the second person 102. That is, the second volume control part 208 controls volume of the second divided sound signal according to whether or not the second person 102 is present in the room 100. The second volume control part 208 sets volume of the second divided sound signal input from the sound source reproduction part 206 to volume instructed by the individual identification part 204.

The third volume control part 209 controls volume of the third divided sound signal according to an identification result of the third person 103. That is, the third volume control part 209 controls volume of the third divided sound signal according to whether or not the third person 103 is present in the room 100. The third volume control part 209 sets volume of the third divided sound signal input from the sound source reproduction part 206 to volume instructed by the individual identification part 204.

The fourth volume control part 210 controls volume of the fourth divided sound signal according to an identification result of the fourth person 104. That is, the fourth volume control part 210 controls volume of the fourth divided sound signal according to whether or not the fourth person 104 is present in the room 100. The fourth volume control part 210 sets volume of the fourth divided sound signal input from the sound source reproduction part 206 to volume instructed by the individual identification part 204.

The mixing part 211 synthesizes the first divided sound signal input from the first volume control part 207, the second divided sound signal input from the second volume control part 208, the third divided sound signal input from the third volume control part 209, and the fourth divided sound signal input from the fourth volume control part 210. The mixing part 211 outputs a synthesized sound signal obtained by synthesizing the first divided sound signal to the fourth divided sound signal to the amplifier 3. The mixing part 211 synthesizes a plurality of divided sound signals according to volume set for each divided sound signal.

The sound reproduction device 2 is connected to a plurality of amplifiers themselves or a hub (not illustrated) such as a communication device or a server in a wired or wireless manner so that a synthesized sound signal obtained by synthesizing a plurality of divided sound signals can be input to the amplifier 3. The sound reproduction device 2 may be communicably connected to the amplifier 3 via a network. The sound reproduction device 2 outputs a synthesized sound signal obtained by synthesizing a plurality of divided sound signals to the amplifier 3.

The amplifier 3 amplifies a synthesized sound signal input from the mixing part 211 of the sound reproduction device 2.

Note that the amplifier 3 may be disposed in the room 100 or may be disposed outside the room 100.

The loudspeaker 4 is disposed in the room 100, converts a synthesized sound signal amplified by the amplifier 3 into a synthesized sound, and emits the synthesized sound into the room 100. In a case where volume of the first divided sound signal is set to a predetermined volume by the first volume control part 207, the loudspeaker 4 emits a first divided sound at the predetermined volume. In a case where volume of the first divided sound signal is set to zero by the first volume control part 207, the loudspeaker 4 does not emit the first divided sound. Further, in a case where volume of the second divided sound signal is set to a predetermined volume by the second volume control part 208, the loudspeaker 4 emits a second divided sound at the predetermined volume. In a case where volume of the second divided sound signal is set to zero by the second volume control part 208, the loudspeaker 4 does not emit the second divided sound. Further, in a case where volume of the third divided sound signal is set to a predetermined volume by the third volume control part 209, the loudspeaker 4 emits a third divided sound at the predetermined volume. In a case where volume of the third divided sound signal is set to zero by the third volume control part 209, the loudspeaker 4 does not emit the third divided sound. Further, in a case where volume of the fourth divided sound signal is set to a predetermined volume by the fourth volume control part 210, the loudspeaker 4 emits a fourth divided sound at the predetermined volume. In a case where volume of the fourth divided sound signal is set to zero by the fourth volume control part 210, the loudspeaker 4 does not emit the fourth divided sound.

Next, sound reproduction processing by the sound reproduction device 2 according to the first embodiment of the present disclosure will be described.

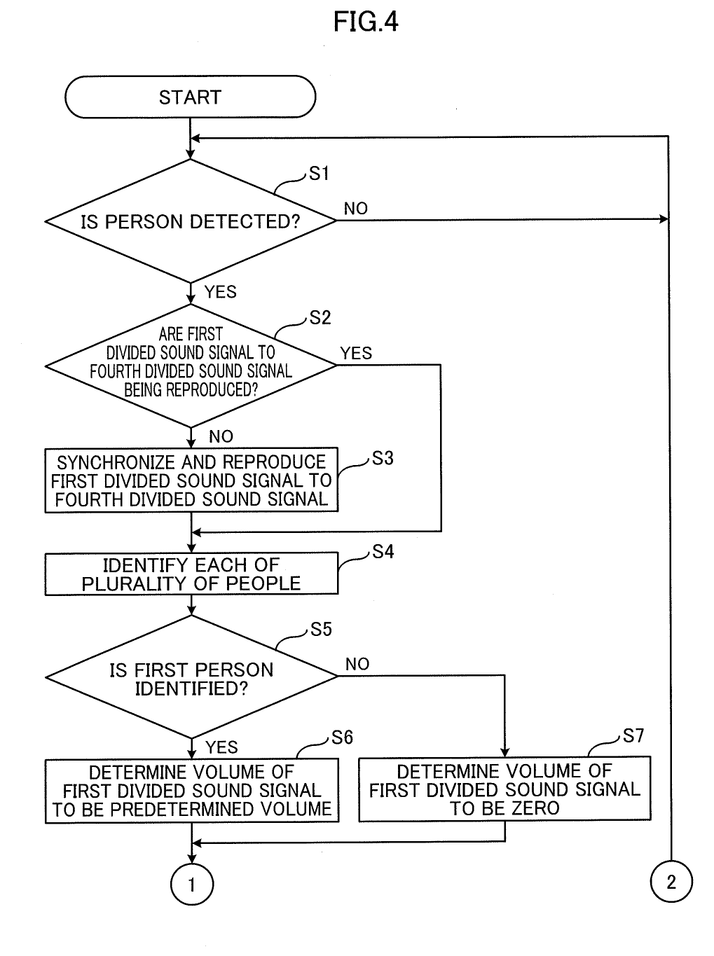

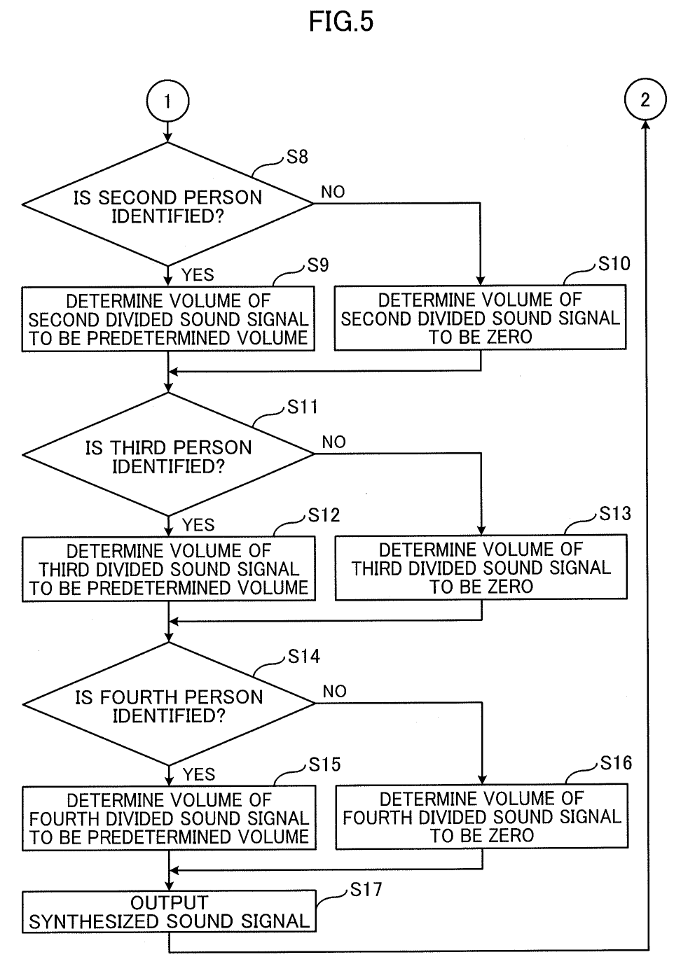

FIG. 4 is a first flowchart for explaining sound reproduction processing by the sound reproduction device 2 in the first embodiment of the present disclosure, and FIG. 5 is a second flowchart for explaining sound reproduction processing by the sound reproduction device 2 in the first embodiment of the present disclosure.

First, in Step S1, the individual identification part 204 determines whether or not a person is detected by the person detection part 201. Here, in a case where it is determined that no person is detected (NO in Step S1), the determination processing in Step S1 is repeatedly performed.

On the other hand, in a case where it is determined that a person is detected (YES in Step S1), in Step S2, the individual identification part 204 determines whether or not the first to fourth divided sound signals obtained by dividing a predetermined sound are being reproduced.

Here, when it is determined that the first to fourth divided sound signals are being reproduced (YES in Step S2), the processing proceeds to Step S4.

On the other hand, in a case where it is determined that the first divided sound signal to the fourth divided sound signal are not being reproduced (NO in Step S2), the sound source reproduction part 206 synchronizes and reproduces the first divided sound signal to the fourth divided sound signal obtained by dividing a predetermined sound in Step S3. At this time, the individual identification part 204 outputs a reproduction start instruction for starting reproduction of a predetermined sound to the sound source reproduction part 206. When the reproduction start instruction is input from the individual identification part 204, the sound source reproduction part 206 reads the first divided sound signal to the fourth divided sound signal from the memory 205, and synchronizes and reproduces the read first divided sound signal to fourth divided sound signal. The sound source reproduction part 206 outputs the reproduced first divided sound signal to fourth divided sound signal to the first volume control part 207 to the fourth volume control part 210, respectively.

Note that, in a case where a meeting is held in the room 100, a plurality of people who are participants of the meeting are determined in advance. By the above, when a person is detected, the sound source reproduction part 206 can synchronize and reproduce a plurality of divided sound signals. For example, when accepting a reservation for use of the room 100, the sound reproduction device 2 may accept input of information for identifying each of a plurality of people who use the room 100.

Next, in Step S4, the individual identification part 204 identifies each of a plurality of people present in the room 100 based on an image captured by the camera 1. The person detection part 201 detects a person from an image captured by the camera 1. The feature extraction part 202 extracts a feature amount of a face of a person detected by the person detection part 201. The individual identification part 204 compares a feature amount of a face extracted by the feature extraction part 202 with each of feature amounts of faces of a plurality of people stored in the personal information database 203. When there is a feature amount that matches a feature amount of a face extracted by the feature extraction part 202 among feature amounts of faces of a plurality of people stored in the personal information database 203, the individual identification part 204 reads identification information associated with the feature amount from the personal information database 203 and identifies a person from the read identification information.

Next, in Step S5, the individual identification part 204 determines whether or not the first person 101 is identified in the room 100. That is, the individual identification part 204 determines whether or not the first person 101 is present in the room 100.

Here, in a case where it is determined that the first person 101 is identified (YES in Step S5), in Step S6, the individual identification part 204 determines volume of the first divided sound signal associated with the first person 101 to be a predetermined volume. The predetermined volume is, for example, maximum volume. The individual identification part 204 sends an instruction to the first volume control part 207 indicating volume of the first divided sound signal determined to be the predetermined volume. The first volume control part 207 sets volume of the first divided sound signal to the predetermined volume based on the instruction from the individual identification part 204. The first volume control part 207 outputs the first divided sound signal with set volume to the mixing part 211.

On the other hand, in a case where it is determined that the first person 101 is not identified (NO in Step S5), in Step S7, the individual identification part 204 determines volume of the first divided sound signal associated with the first person 101 to be zero. The individual identification part 204 sends an instruction to the first volume control part 207 indicating volume of the first divided sound signal determined to be zero. The first volume control part 207 sets volume of the first divided sound signal to zero based on the instruction from the individual identification part 204. The first volume control part 207 outputs the first divided sound signal with set volume to the mixing part 211.

Next, in Step S8, the individual identification part 204 determines whether or not the second person 102 is identified in the room 100. That is, the individual identification part 204 determines whether or not the second person 102 is present in the room 100.

Here, in a case where it is determined that the second person 102 is identified (YES in Step S8), in Step S9, the individual identification part 204 determines volume of the second divided sound signal associated with the second person 102 to be a predetermined volume. The predetermined volume is, for example, maximum volume. The individual identification part 204 sends an instruction to the second volume control part 208 indicating volume of the second divided sound signal determined to be the predetermined volume. The second volume control part 208 sets volume of the second divided sound signal to the predetermined volume based on the instruction from the individual identification part 204. The second volume control part 208 outputs the second divided sound signal with set volume to the mixing part 211.

On the other hand, in a case where it is determined that the second person 102 is not identified (NO in Step S8), in Step S10, the individual identification part 204 determines volume of the second divided sound signal associated with the second person 102 to be zero. The individual identification part 204 sends an instruction to the second volume control part 208 indicating volume of the second divided sound signal determined to be zero. The second volume control part 208 sets volume of the second divided sound signal to zero based on the instruction from the individual identification part 204. The second volume control part 208 outputs the second divided sound signal with set volume to the mixing part 211.

Next, in Step S11, the individual identification part 204 determines whether or not the third person 103 is identified in the room 100. That is, the individual identification part 204 determines whether or not the third person 103 is present in the room 100.

Here, in a case where it is determined that the third person 103 is identified (YES in Step S11), in Step S12, the individual identification part 204 determines volume of the third divided sound signal associated with the third person 103 to be a predetermined volume. The predetermined volume is, for example, maximum volume. The individual identification part 204 sends an instruction to the third volume control part 209 indicating volume of the third divided sound signal determined to be the predetermined volume. The third volume control part 209 sets volume of the third divided sound signal to the predetermined volume based on the instruction from the individual identification part 204. The third volume control part 209 outputs the third divided sound signal with set volume to the mixing part 211.

On the other hand, in a case where it is determined that the third person 103 is not identified (NO in Step S11), in Step S13, the individual identification part 204 determines volume of the third divided sound signal associated with the third person 103 to be zero. The individual identification part 204 sends an instruction to the third volume control part 209 indicating volume of the third divided sound signal determined to be zero. The third volume control part 209 sets volume of the third divided sound signal to zero based on the instruction from the individual identification part 204. The third volume control part 209 outputs the third divided sound signal with set volume to the mixing part 211.

Next, in Step S14, the individual identification part 204 determines whether or not the fourth person 104 is identified in the room 100. That is, the individual identification part 204 determines whether or not the fourth person 104 is present in the room 100.

Here, in a case where it is determined that the fourth person 104 is identified (YES in Step S14), in Step S15, the individual identification part 204 determines volume of the fourth divided sound signal associated with the fourth person 104 to be a predetermined volume. The predetermined volume is, for example, maximum volume. The individual identification part 204 sends an instruction to the fourth volume control part 210 indicating volume of the fourth divided sound signal determined to be the predetermined volume. The fourth volume control part 210 sets volume of the fourth divided sound signal to the predetermined volume based on the instruction from the individual identification part 204. The fourth volume control part 210 outputs the fourth divided sound signal with set volume to the mixing part 211.

On the other hand, in a case where it is determined that the fourth person 104 is not identified (NO in Step S14), in Step S16, the individual identification part 204 determines volume of the fourth divided sound signal associated with the fourth person 104 to be zero. The individual identification part 204 sends an instruction to the fourth volume control part 210 indicating volume of the fourth divided sound signal determined to be zero. The fourth volume control part 210 sets volume of the fourth divided sound signal to zero based on the instruction from the individual identification part 204. The fourth volume control part 210 outputs the fourth divided sound signal with set volume to the mixing part 211.

Next, in Step S17, the mixing part 211 outputs a synthesized sound signal obtained by synthesizing the first divided sound signal to the fourth divided sound signal with set volume to the amplifier 3. The amplifier 3 amplifies the synthesized sound signal and outputs the amplified synthesized sound signal to the loudspeaker 4. The loudspeaker 4 converts the synthesized sound signal into a synthesized sound, and emits, into the room 100, a synthesized sound obtained by synthesizing the first divided sound to the fourth divided sound to which the first volume control part 207 to the fourth volume control part 210 set respective volumes.

By the above, when the first person 101 is present in the room 100, the first divided sound with a predetermined volume is output from the loudspeaker 4, and when the first person 101 is not present in the room 100, the first divided sound is not output from the loudspeaker 4. Further, when the second person 102 is present in the room 100, the second divided sound with a predetermined volume is output from the loudspeaker 4, and when the second person 102 is not present in the room 100, the second divided sound is not output from the loudspeaker 4. Further, when the third person 103 is present in the room 100, the third divided sound with a predetermined volume is output from the loudspeaker 4, and when the third person 103 is not present in the room 100, the third divided sound is not output from the loudspeaker 4. Further, when the fourth person 104 is present in the room 100, the fourth divided sound with a predetermined volume is output from the loudspeaker 4, and when the fourth person 104 is not present in the room 100, the fourth divided sound is not output from the loudspeaker 4.

As described above, when a plurality of people gather in the room 100, a plurality of divided sounds overlap each other, and one predetermined harmonious sound is output. For this reason, a plurality of people can be gathered in the room 100, and a conversation of a plurality of people in the room 100 can be promoted. For example, in a case where a meeting is held in the room 100, many people participating in the meeting can be gathered.

Note that, in the first embodiment, a person in a predetermined space is identified based on a feature amount of a face of the person extracted from an image captured by the camera 1, but the present disclosure is not particularly limited to this, and other identification methods may be used. For example, a person may be identified by a fingerprint, a person may be identified by an iris, a person may be identified by a feature amount of a voice (voiceprint), a person may be identified by a movement of a hand or a gesture, a person may be identified by a shape or a contour of a body, a person may be identified by a beacon device using near field communication, and a person may be identified by an ID card.

Further, in the first embodiment, the individual identification part 204 identifies a person who is in a predetermined space every predetermined period (for example, every minute), but the present invention is not limited to this. For example, in a case where an ID card is used to identify a person, the person may be identified by reading information of the ID card by using a card reader or the like at the start of a meeting or at the time when the person enters a predetermined space. Then, after the person is identified, until the information of the ID card is read again by using the card reader or the like at the end of the meeting or at the time when the person leaves the predetermined space, the individual identification part 204 may cause a divided sound signal corresponding to the person to be output by assuming that the person is identified.

Further, in a modification example of the first embodiment, the individual identification part 204 may select one sound from a plurality of sounds of different types (genres), and instruct the sound source reproduction part 206 to reproduce a plurality of divided sound signals obtained by dividing the selected one sound.

For example, types (genres) of sound include jazz, pop, orchestral, and classical. The sound reproduction device 2 may receive selection of one sound by a person from among a plurality of sounds of different types (genres). Then, the individual identification part 204 may output a reproduction start instruction for starting reproduction of the sound selected by the person to the sound source reproduction part 206. Further, the individual identification part 204 may select a sound corresponding to a current time period from among a plurality of sounds of different types (genres), and output a reproduction start instruction for starting reproduction of the selected sound to the sound source reproduction part 206.

Further, each of a plurality of sounds may be divided according to a performance part of music to be reproduced. For example, each of a plurality of sounds may be divided into the first divided sound signal representing a melody part playing a main melody, the second divided sound signal representing a harmony part playing a chord or a secondary melody for the melody part, the third divided sound signal representing a rhythm part responsible for a rhythm of music, and the fourth divided sound signal representing a bass part responsible for a low frequency range.

Further, each of the plurality of sounds may be divided according to a type of musical instrument to be played. For example, in a case where a sound of “Jazz” is selected, the first divided sound representing a drum sound, the second divided sound representing a bass sound, the third divided sound representing a keyboard sound, and the fourth divided sound representing a guitar sound may be emitted to the room 100.

Further, one divided sound signal may include sounds of a plurality of musical instruments. For example, the first divided sound signal may include a bass sound and a guitar sound.

Further, in the first embodiment, the sound source reproduction part 206 may continuously reproduce a background sound signal different from a plurality of divided sound signals. The sound source reproduction part 206 may output the background sound signal to a fifth volume control part different from the first volume control part 207 to the fourth volume control part 210. The fifth volume control part may set volume of the background sound signal to a predetermined volume (for example, maximum volume). The mixing part 211 may output a synthesized sound signal obtained by synthesizing the first divided sound signal, the second divided sound signal, the third divided sound signal, the fourth divided sound signal, and the background sound signal to the amplifier 3. The loudspeaker 4 may continuously emit a background sound, and may emit the first to fourth divided sounds in a manner overlapping the background sound.

Note that the background sound may be, for example, a natural sound such as a wind sound, a sound of running water, a chirping sound of an insect, or a chirping sound of a bird. A natural sound has an effect of calming the mind of a person, and by continuously reproducing a natural sound in a predetermined space, it is possible to gather people in the predetermined space.

Further, the background sound may be, for example, a sound of a musical instrument that covers a frequency band of human voice. A frequency band of an electronic piano sound overlaps a frequency band of a human voice, and the sound source reproduction part 206 may continuously reproduce an electronic piano sound signal as the background sound signal separately from a plurality of divided sound signals.

Further, in the first embodiment, in a case where a meeting is held in the room 100, a plurality of people who are participants of the meeting do not need to be determined in advance. For example, when a person in a predetermined space as a participant of a meeting is a person registered in the personal information database 203, a divided sound signal associated with the person is reproduced. On the other hand, when a participant of a meeting is a person who is not registered in the personal information database 203, any one divided sound signal other than a divided sound signal already associated as a divided sound signal of any person in a predetermined space may be reproduced as a divided sound signal of the person. Further, identification information of the person and the divided sound signal may be registered in the personal information database 203 in association with each other. In this case, registration information of a person not originally registered in the personal information database 203 may be deleted from the personal information database 203 after a predetermined period. Note that the predetermined period is, for example, a period during which a meeting is held, and may be a period of one day or several days.

### Second embodiment

In the sound reproduction device 2 described in the first embodiment, each of a plurality of people is identified, and volume of each of a plurality of divided sound signals is controlled according to whether or not each of the plurality of people is identified; however, in the sound reproduction device described in a second embodiment, sound information indicating an average volume of voices of each of a plurality of people in a predetermined period is acquired, and volume of each of a plurality of divided sound signals is controlled according to sound information of each of the plurality of people.

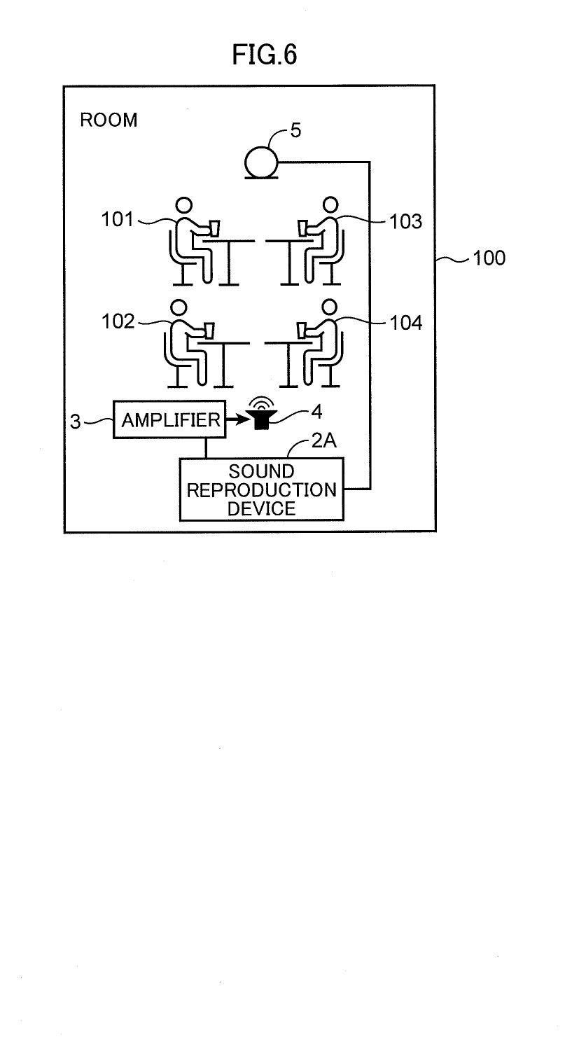

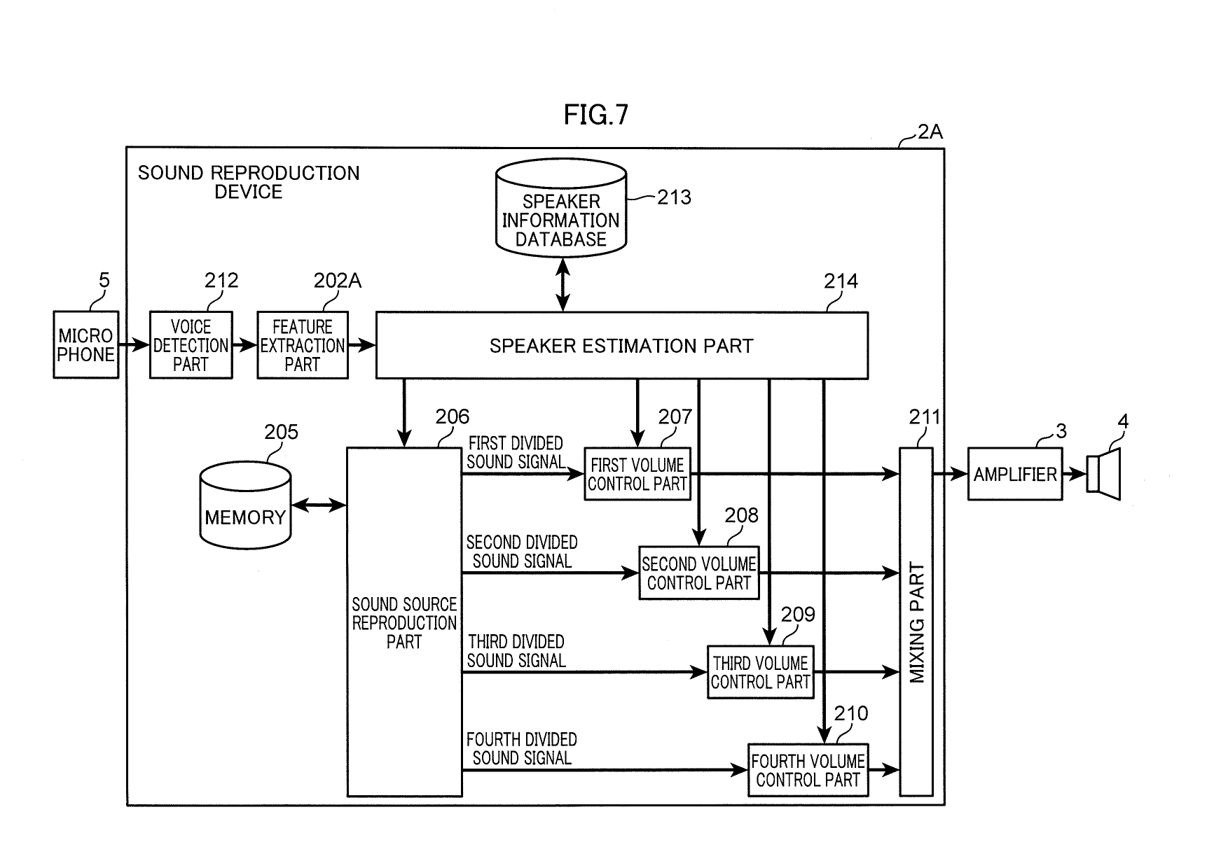

FIG. 6 is a diagram illustrating an overall configuration of the sound reproduction system according to the second embodiment, and FIG. 7 is a block diagram illustrating a configuration of a sound reproduction device 2A according to the second embodiment.

The sound reproduction system according to the second embodiment includes a microphone 5, a sound reproduction device 2A, the amplifier 3, and the loudspeaker 4. Note that, in the second embodiment, the same configuration as that in the first embodiment will be denoted by the same reference sign as that in the first embodiment, and will be omitted from description.

The microphone 5 collects sounds in a predetermined space. The microphone 5 is disposed at a position where sounds in a predetermined space can be collected. The predetermined space is, for example, a room 100 such as a conference room in which a plurality of people (a first person 101, a second person 102, a third person 103, and a fourth person 104) can gather. In the second embodiment, the microphone 5 collects voices of a plurality of people (the first person 101, the second person 102, the third person 103, and the fourth person 104) in the room 100.

The microphone 5 is connected to the sound reproduction device 2A itself or a hub (not illustrated) such as a communication device or a server in a wired or wireless manner so that a collected sound can be input to the sound reproduction device 2A. The microphone 5 may be communicably connected to the sound reproduction device 2A via a network. The microphone 5 outputs a collected sound to the sound reproduction device 2A.

Note that a sound collected by the microphone 5 may be output in real time, or after the sound is once recorded in an external storage device such as a memory or a cloud server, the sound may be output from the external storage device.

The sound reproduction device 2A acquires information on a plurality of people in a predetermined space, synchronizes and reproduces a plurality of divided sound signals obtained by dividing a predetermined sound, and outputs, based on the information on the plurality of people, a plurality of divided sound signals to the loudspeaker that emits, to the predetermined space, a plurality of divided sounds converted from the plurality of divided sound signals. The sound reproduction device 2A detects voices of a plurality of people (the first person 101, the second person 102, the third person 103, and the fourth person 104) present in a predetermined space (the room 100) based on a sound collected by the microphone 5. The sound reproduction device 2A controls volume of each of a plurality of divided sound signals according to an average volume of voices in a predetermined period of each of a plurality of people (the first person 101, the second person 102, the third person 103, and the fourth person 104). The sound reproduction device 2A changes volume of each of the first divided sound signal to the fourth divided sound signal according to an average volume of voices in a predetermined period of each of a plurality of people (the first person 101, the second person 102, the third person 103, and the fourth person 104).

The sound reproduction device 2A includes at least a computer system including, for example, a control program, a processing circuit such as a processor or a logic circuit that executes the control program, and a recording device such as an internal memory or an accessible external memory that stores the control program. Note that the sound reproduction device 2A may be implemented by, for example, hardware implementation by a processing circuit, execution of a software program held in a memory by a processing circuit or distributed from an external server, or a combination of these hardware implementation and software implementation.

The sound reproduction device 2A includes a voice detection part 212, a feature extraction part 202A, a speaker information database 213, a speaker estimation part 214, the memory 205, the sound source reproduction part 206, the first volume control part 207, the second volume control part 208, the third volume control part 209, the fourth volume control part 210, and the mixing part 211.

The voice detection part 212 detects a voice of a person in the room 100 based on a sound collected by the microphone 5.

The feature extraction part 202A extracts a feature amount of a voice of a person detected by the voice detection part 212.

The speaker information database 213 stores feature amounts of voices of a plurality of people and identification information (user IDs) for identifying the plurality of people in association with each other. Here, a method of registering a feature amount of a voice of a person in the speaker information database 213 will be described. First, a sound including a voice of a person is collected by a microphone. Next, a voice of a person is detected from a collected sound, and a feature amount of the detected voice of the person is extracted. Next, identification information of the person is input by an input device such as a touch panel. Next, the feature amount of the voice of the person and the identification information of the person are stored in the speaker information database 213 in association with each other.

Further, the speaker information database 213 stores identification information for identifying a plurality of people and a preferred musical instrument of the plurality of people in association with each other.

The speaker estimation part 214 outputs a reproduction start instruction for starting reproduction of a predetermined sound to the sound source reproduction part 206. In a case where a voice of a person is detected by the voice detection part 212, the speaker estimation part 214 outputs a reproduction start instruction to the sound source reproduction part 206. Further, in a case where a voice of a person is no longer detected by the voice detection part 212, the speaker estimation part 214 may output a reproduction end instruction for ending reproduction of a predetermined sound to the sound source reproduction part 206. Further, the speaker estimation part 214 may output a reproduction start instruction to the sound source reproduction part 206 in a case where a voice of one of a plurality of people is identified.

Further, the speaker estimation part 214 may select a sound corresponding to a current time period from among a plurality of sounds of different types, and output a reproduction start instruction for starting reproduction of the selected sound to the sound source reproduction part 206. For example, the speaker estimation part 214 may select a sound corresponding to a current time period from among a first sound corresponding to a time period in the morning (8:00 AM to 12:00 PM), a second sound corresponding to a time period in the afternoon (12:00 PM to 6:00 PM), and a third sound corresponding to a time period in the night (6:00 PM to 10:00 PM). Note that the time period is not limited to the above.

The speaker estimation part 214 acquires information on a plurality of people in a predetermined space. The speaker estimation part 214 acquires voice information indicating an average volume of voices of a plurality of people in a predetermined period. The speaker estimation part 214 controls volume of each of a plurality of divided sound signals according to voice information of each of a plurality of people.

The speaker estimation part 214 estimates which person is the speaker of a voice detected by the voice detection part 212, and calculates an average volume of voices of the estimated person in a predetermined period. The speaker estimation part 214 compares a feature amount of a voice extracted by the feature extraction part 202A with each of feature amounts of voices of a plurality of people stored in the speaker information database 213. If there is a feature amount that matches a feature amount of a voice extracted by the feature extraction part 202A among feature amounts of voices of a plurality of people stored in the speaker information database 213, the speaker estimation part 214 reads identification information associated with the feature amount from the speaker information database 213, and estimates a person as a speaker from the read identification information.

Note that the speaker estimation part 214 may store voice data of a voice of each of a plurality of people in a past predetermined period. Further, the speaker estimation part 214 may store volume data of a voice of each of a plurality of people in a past predetermined period.

A plurality of people and a plurality of divided sound signals are associated with each other in advance. The speaker estimation part 214 refers to the speaker information database 213, extracts a preferred musical instrument corresponding to a user ID of an estimated speaker, and associates a divided sound signal corresponding to the extracted preferred musical instrument among a plurality of divided sound signals as a divided sound signal of the speaker.

The speaker estimation part 214 determines volume of the first divided sound signal associated with the first person 101 according to an average volume of voices of the first person 101 who is a speaker in a predetermined period, and sends an instruction to the first volume control part 207 indicating the determined volume. The speaker estimation part 214 determines volume of the second divided sound signal associated with the second person 102 according to an average volume of voices of the second person 102 who is a speaker in a predetermined period, and sends an instruction to the second volume control part 208 indicating the determined volume. The speaker estimation part 214 determines volume of the third divided sound signal associated with the third person 103 according to an average volume of voices of the third person 103 who is a speaker in a predetermined period, and sends an instruction to the third volume control part 209 indicating the determined volume. The speaker estimation part 214 determines volume of the fourth divided sound signal associated with the fourth person 104 according to an average volume of voices of the fourth person 104 who is a speaker in a predetermined period, and sends an instruction to the fourth volume control part 210 indicating the determined volume.

In a case where an average volume of voices of a person who is a speaker in a predetermined period is smaller than a threshold, the speaker estimation part 214 determines volume of a divided sound signal associated with the person to be a predetermined volume. The predetermined volume is, for example, maximum volume. Further, in a case where an average volume of voices of a person who is a speaker in a predetermined period is equal to or more than a threshold, the speaker estimation part 214 determines volume of a divided sound signal associated with the person to be zero. Note that, the predetermined volume is not limited to maximum volume, and may be 50% or 80% of maximum volume, and only needs to be larger than 0.

In a case where an average volume of voices of the first person 101 in a predetermined period is smaller than a threshold, the speaker estimation part 214 determines volume of the first divided sound signal associated with the first person 101 to be a predetermined volume. Further, in a case where an average volume of voices of the first person 101 in a predetermined period is equal to or more than a threshold, the speaker estimation part 214 determines volume of the first divided sound signal associated with the first person 101 to be zero.

In a case where an average volume of voices of the second person 102 in a predetermined period is smaller than a threshold, the speaker estimation part 214 determines volume of the second divided sound signal associated with the second person 102 to be a predetermined volume. Further, in a case where an average volume of voices of the second person 102 in a predetermined period is equal to or more than a threshold, the speaker estimation part 214 determines volume of the second divided sound signal associated with the second person 102 to be zero.

In a case where an average volume of voices of the third person 103 in a predetermined period is smaller than a threshold, the speaker estimation part 214 determines volume of the third divided sound signal associated with the third person 103 to be a predetermined volume. Further, in a case where an average volume of voices of the third person 103 in a predetermined period is equal to or more than a threshold, the speaker estimation part 214 determines volume of the third divided sound signal associated with the third person 103 to be zero.

In a case where an average volume of voices of the fourth person 104 in a predetermined period is smaller than a threshold, the speaker estimation part 214 determines a volume of the fourth divided sound signal associated with the fourth person 104 to be a predetermined volume. Further, in a case where an average volume of voices of the fourth person 104 in a predetermined period is equal to or more than a threshold, the speaker estimation part 214 determines volume of the fourth divided sound signal associated with the fourth person 104 to be zero.

Note that, in the second embodiment, the number of a plurality of people is four, but the present disclosure is not particularly limited to this, and the number of a plurality of people may be two or more.

When a reproduction start instruction is input from the speaker estimation part 214, the sound source reproduction part 206 starts reproduction of a plurality of divided sound signals obtained by dividing the predetermined sound. Further, when a reproduction end instruction is input from the speaker estimation part 214, the sound source reproduction part 206 ends reproduction of a plurality of divided sound signals obtained by dividing the predetermined sound.

The sound source reproduction part 206 synchronizes and reproduces all of the first divided sound signal to the fourth divided sound signal regardless of whether or not the first person 101 to the fourth person 104 are present in the room 100. That is, when a voice of at least one of the first person 101 to the fourth person 104 is detected, the sound source reproduction part 206 synchronizes and reproduces all of the first to fourth divided sound signals.

The first volume control part 207 to the fourth volume control part 210 control volume of each of a plurality of divided sound signals according to an average volume of voices in a predetermined period of each of a plurality of people.

The first volume control part 207 controls volume of the first divided sound signal according to an average volume of voices of the first person 101 in a predetermined period. The first volume control part 207 sets volume of the first divided sound signal input from the sound source reproduction part 206 to the volume instructed by the speaker estimation part 214.

The second volume control part 208 controls volume of the second divided sound signal according to an average volume of voices of the second person 102 in a predetermined period. The second volume control part 208 sets volume of the second divided sound signal input from the sound source reproduction part 206 to the volume instructed by the speaker estimation part 214.

The third volume control part 209 controls volume of the third divided sound signal according to an average volume of voices of the third person 103 in a predetermined period. The third volume control part 209 sets volume of the third divided sound signal input from the sound source reproduction part 206 to the volume instructed by the speaker estimation part 214.

The fourth volume control part 210 controls volume of the fourth divided sound signal according to an average volume of voices of the fourth person 104 in a predetermined period. The fourth volume control part 210 sets volume of the fourth divided sound signal input from the sound source reproduction part 206 to the volume instructed by the speaker estimation part 214.

Next, sound reproduction processing by the sound reproduction device 2A according to the second embodiment of the present disclosure will be described.

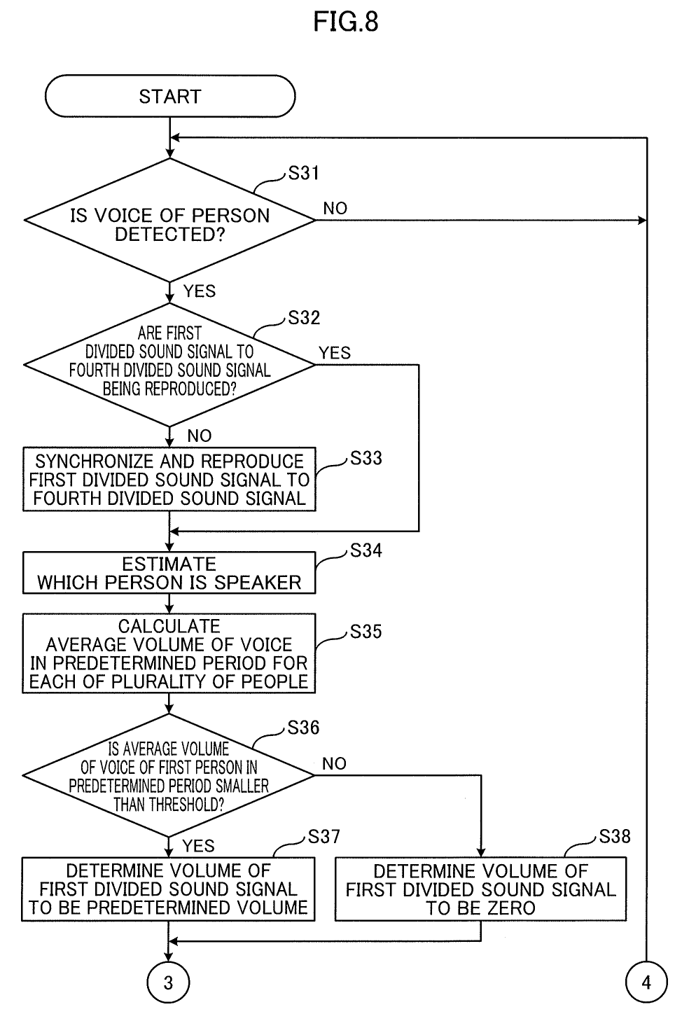

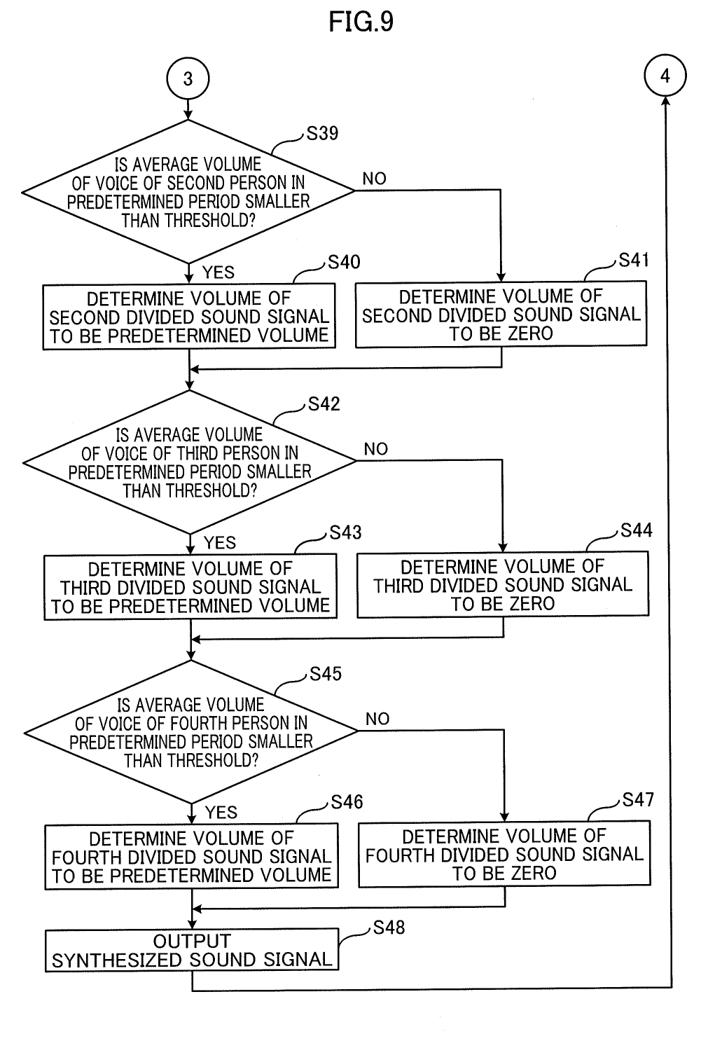

FIG. 8 is a first flowchart for explaining sound reproduction processing by the sound reproduction device 2A in the second embodiment of the present disclosure, and FIG. 9 is a second flowchart for explaining sound reproduction processing by the sound reproduction device 2A in the second embodiment of the present disclosure.

First, in Step S31, the speaker estimation part 214 determines whether or not a voice of a person is detected by the voice detection part 212. Here, in a case where it is determined that no voice of a person is detected (NO in Step S31), the determination processing in Step S31 is repeatedly performed.

On the other hand, in a case where it is determined that a voice of a person is detected (YES in Step S31), in Step S32, the speaker estimation part 214 determines whether or not the first to fourth divided sound signals obtained by dividing a predetermined sound are being reproduced.

Here, when it is determined that the first to fourth divided sound signals are being reproduced (YES in Step S32), the processing proceeds to Step S34.

On the other hand, in a case where it is determined that the first divided sound signal to the fourth divided sound signal are not being reproduced (NO in Step S32), the sound source reproduction part 206 synchronizes and reproduces the first divided sound signal to the fourth divided sound signal obtained by dividing a predetermined sound in Step S33. At this time, the speaker estimation part 214 outputs a reproduction start instruction for starting reproduction of a predetermined sound to the sound source reproduction part 206. When the reproduction start instruction is input from the speaker estimation part 214, the sound source reproduction part 206 reads the first divided sound signal to the fourth divided sound signal from the memory 205, and synchronizes and reproduces the read first divided sound signal to fourth divided sound signal. The sound source reproduction part 206 outputs the reproduced first divided sound signal to fourth divided sound signal to the first volume control part 207 to the fourth volume control part 210, respectively.

Next, in Step S34, the speaker estimation part 214 estimates a person who is a speaker of the voice detected by the voice detection part 212. The speaker estimation part 214 compares a feature amount of a voice extracted by the feature extraction part 202A with each of feature amounts of voices of a plurality of people stored in the speaker information database 213. If there is a feature amount that matches a feature amount of a voice extracted by the feature extraction part 202A among feature amounts of voices of a plurality of people stored in the speaker information database 213, the speaker estimation part 214 reads identification information associated with the feature amount from the speaker information database 213, and estimates a person as a speaker from the read identification information.

Next, in Step S35, the speaker estimation part 214 calculates an average volume of voices of each of a plurality of people in a predetermined period. For example, the speaker estimation part 214 calculates an average volume of voices in a period from the current time to the time one minute before.

Next, in Step S36, the speaker estimation part 214 determines whether or not an average volume of voices of the first person 101 in a predetermined period is smaller than a threshold.

Here, in a case where it is determined that the average volume of the voices of the first person 101 in the predetermined period is smaller than the threshold (YES in Step S36), in Step S37, the speaker estimation part 214 determines volume of the first divided sound signal associated with the first person 101 to be a predetermined volume. The predetermined volume is, for example, maximum volume. The speaker estimation part 214 sends an instruction to the first volume control part 207 indicating the volume of the first divided sound signal determined to be the predetermined volume. The first volume control part 207 sets volume of the first divided sound signal to the predetermined volume based on the instruction from the speaker estimation part 214. The first volume control part 207 outputs the first divided sound signal with set volume to the mixing part 211.

On the other hand, in a case where it is determined that the average volume of the voices of the first person 101 in the predetermined period is equal to or more than the threshold (NO in Step S36), the speaker estimation part 214 determines volume of the first divided sound signal associated with the first person 101 to be zero in Step S38. The speaker estimation part 214 sends an instruction to the first volume control part 207 indicating the volume of the first divided sound signal determined to be zero. The first volume control part 207 sets volume of the first divided sound signal to zero based on the instruction from the speaker estimation part 214. The first volume control part 207 outputs the first divided sound signal with set volume to the mixing part 211.

Next, in Step S39, the speaker estimation part 214 determines whether or not an average volume of voices of the second person 102 in a predetermined period is smaller than a threshold.

Here, in a case where it is determined that the average volume of the voices of the second person 102 in the predetermined period is smaller than the threshold (YES in Step S39), in Step S40, the speaker estimation part 214 determines volume of the second divided sound signal associated with the second person 102 to be a predetermined volume. The predetermined volume is, for example, maximum volume. The speaker estimation part 214 sends an instruction to the second volume control part 208 indicating the volume of the second divided sound signal determined to be the predetermined volume. The second volume control part 208 sets volume of the second divided sound signal to the predetermined volume based on the instruction from the speaker estimation part 214. The second volume control part 208 outputs the second divided sound signal with set volume to the mixing part 211.

On the other hand, in a case where it is determined that the average volume of the voices of the second person 102 in the predetermined period is equal to or more than the threshold (NO in Step S39), the speaker estimation part 214 determines volume of the second divided sound signal associated with the second person 102 to be zero in Step S41. The speaker estimation part 214 sends an instruction to the second volume control part 208 indicating the volume of the second divided sound signal determined to be zero. The second volume control part 208 sets volume of the second divided sound signal to zero based on the instruction from the speaker estimation part 214. The second volume control part 208 outputs the second divided sound signal with set volume to the mixing part 211.

Next, in Step S42, the speaker estimation part 214 determines whether or not an average volume of voices of the third person 103 in a predetermined period is smaller than a threshold.

Here, in a case where it is determined that the average volume of the voices of the third person 103 in the predetermined period is smaller than the threshold (YES in Step S42), in Step S43, the speaker estimation part 214 determines volume of the third divided sound signal associated with the third person 103 to be a predetermined volume. The predetermined volume is, for example, maximum volume. The speaker estimation part 214 sends an instruction to the third volume control part 209 indicating the volume of the third divided sound signal determined to be the predetermined volume. The third volume control part 209 sets volume of the third divided sound signal to the predetermined volume based on the instruction from the speaker estimation part 214. The third volume control part 209 outputs the third divided sound signal with set volume to the mixing part 211.

On the other hand, in a case where it is determined that the average volume of the voices of the third person 103 in the predetermined period is equal to or more than the threshold (NO in Step S42), the speaker estimation part 214 determines volume of the third divided sound signal associated with the third person 103 to be zero in Step S44. The speaker estimation part 214 sends an instruction to the third volume control part 209 indicating the volume of the third divided sound signal determined to be zero. The third volume control part 209 sets volume of the third divided sound signal to zero based on the instruction from the speaker estimation part 214. The third volume control part 209 outputs the third divided sound signal with set volume to the mixing part 211.

Next, in Step S45, the speaker estimation part 214 determines whether or not an average volume of voices of the fourth person 104 in a predetermined period is smaller than a threshold.

Here, in a case where it is determined that the average volume of the voices of the fourth person 104 in the predetermined period is smaller than the threshold (YES in Step S45), in Step S46, the speaker estimation part 214 determines volume of the fourth divided sound signal associated with the fourth person 104 to be a predetermined volume. The predetermined volume is, for example, maximum volume. The speaker estimation part 214 sends an instruction to the fourth volume control part 210 indicating the volume of the fourth divided sound signal determined to be the predetermined volume. The fourth volume control part 210 sets volume of the fourth divided sound signal to the predetermined volume based on the instruction from the speaker estimation part 214. The fourth volume control part 210 outputs the fourth divided sound signal with set volume to the mixing part 211.

On the other hand, in a case where it is determined that the average volume of the voices of the fourth person 104 in the predetermined period is equal to or more than the threshold (NO in Step S45), the speaker estimation part 214 determines volume of the fourth divided sound signal associated with the fourth person 104 to be zero in Step S47. The speaker estimation part 214 sends an instruction to the fourth volume control part 210 indicating the volume of the fourth divided sound signal determined to be zero. The fourth volume control part 210 sets volume of the fourth divided sound signal to zero based on the instruction from the speaker estimation part 214. The fourth volume control part 210 outputs the fourth divided sound signal with set volume to the mixing part 211.

Next, in Step S48, the mixing part 211 outputs a synthesized sound signal obtained by synthesizing the first divided sound signal to the fourth divided sound signal with set volume to the amplifier 3. The amplifier 3 amplifies the synthesized sound signal and outputs the amplified synthesized sound signal to the loudspeaker 4. The loudspeaker 4 converts the synthesized sound signal into a synthesized sound, and emits, into the room 100, a synthesized sound obtained by synthesizing the first divided sound to the fourth divided sound to which the first volume control part 207 to the fourth volume control part 210 set respective volumes.

By the above, when an average volume of voices of the first person 101 in a predetermined period is smaller than a threshold, the first divided sound at a predetermined volume is output from the loudspeaker 4, and when the average volume of the voices of the first person 101 in the predetermined period is equal to or more than the threshold, the first divided sound is not output from the loudspeaker 4. Further, when an average volume of voices of the second person 102 in a predetermined period is smaller than a threshold, the second divided sound at a predetermined volume is output from the loudspeaker 4, and when the average volume of the voices of the second person 102 in the predetermined period is equal to or more than the threshold, the second divided sound is not output from the loudspeaker 4. Further, when an average volume of voices of the third person 103 in a predetermined period is smaller than a threshold, the third divided sound at a predetermined volume is output from the loudspeaker 4, and when the average volume of the voices of the third person 103 in the predetermined period is equal to or more than the threshold, the third divided sound is not output from the loudspeaker 4. Further, when an average volume of voices of the fourth person 104 in a predetermined period is smaller than a threshold, the fourth divided sound at a predetermined volume is output from the loudspeaker 4, and when the average volume of the voices of the fourth person 104 in the predetermined period is equal to or more than the threshold, the fourth divided sound is not output from the loudspeaker 4.

It can also be said that an average volume of voices in a predetermined period is an amount of speech of a person. As described above, in a case where an amount of speech of a person is small, a divided sound associated with the person is output, and in a case where the amount of speech of the person is large, the divided sound associated with the person is not output, and therefore, a person with a small amount of speech can be made to recognize that the amount of speech is small, and a person with a small amount of speech can be prompted to speak.

Note that the speaker estimation part 214 may select a predetermined sound according to an average volume of voices of all of a plurality of people in a predetermined period. In a case where an average volume of voices of all of a plurality of people in a predetermined period is smaller than a threshold, the speaker estimation part 214 may select music having a fast tempo such that Beats Per Minute (BPM) is equal to or more than the threshold. By the above, it is possible to provide a sound environment in which a plurality of people can easily make a conversation. Further, in a case where an average volume of voices of all of a plurality of people in a predetermined period is equal to or more than the threshold, the speaker estimation part 214 may select music having a slow tempo such that BPM is smaller than the threshold. By the above, it is possible to provide a sound environment in which a plurality of people have a conversation in a calm manner.

Note that, in a case where an average volume of voices of a person who is a speaker in a predetermined period is equal to or more than a threshold, the speaker estimation part 214 may determine volume of a divided sound signal associated with the person to be a predetermined volume. The predetermined volume is, for example, maximum volume. Further, in a case where an average volume of voices of a person who is a speaker in a predetermined period is smaller than a threshold, the speaker estimation part 214 may determine volume of a divided sound signal associated with the person to be zero. Note that, the predetermined volume is not limited to maximum volume, and may be 50% or 80% of maximum volume, and only needs to be larger than 0. By the above, for example, since volume of a divided sound signal of a person who remains silent for a while becomes zero, the person who remains silent for a while can be prompted to speak.

### Third embodiment

In the sound reproduction device described in a third embodiment, posture information related to a posture of each of a plurality of people is acquired, and volume of each of a plurality of divided sound signals is controlled according to the posture of each of the plurality of people.

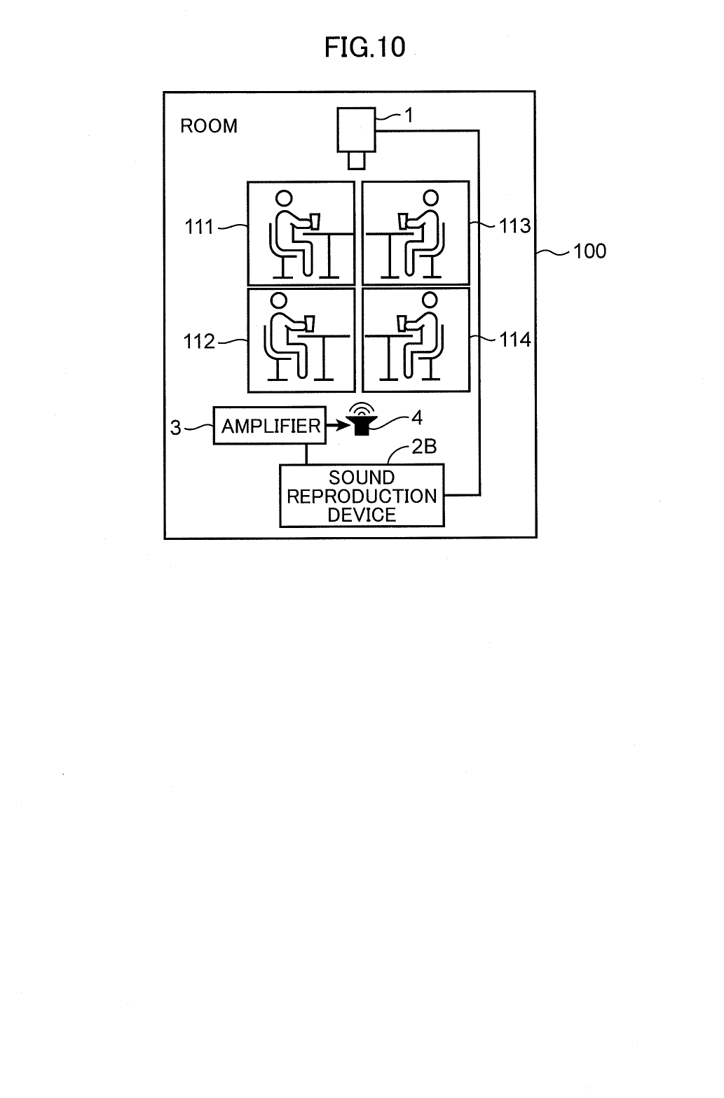

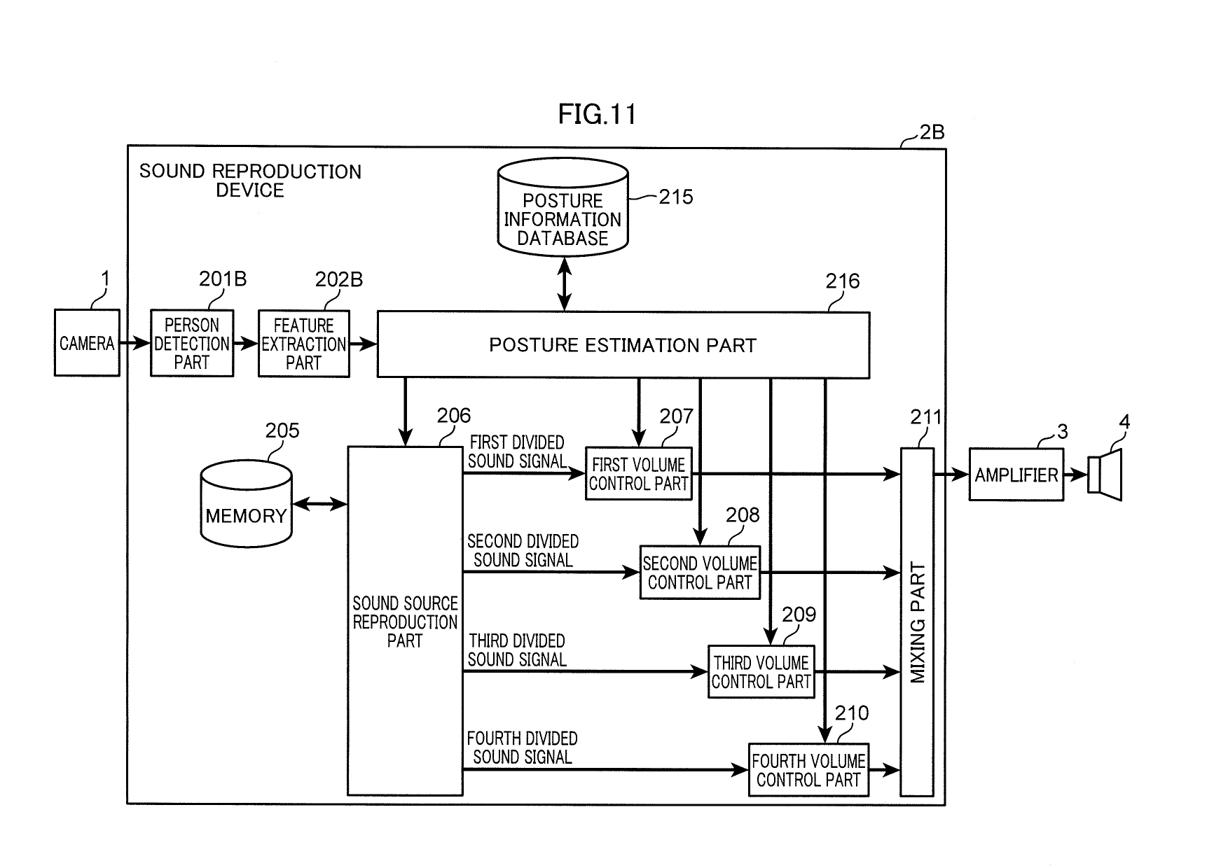

FIG. 10 is a diagram illustrating an overall configuration of the sound reproduction system according to the third embodiment, and FIG. 11 is a block diagram illustrating a configuration of a sound reproduction device 2B according to the third embodiment.

The sound reproduction system according to the third embodiment includes the camera 1, a sound reproduction device 2B, the amplifier 3, and the loudspeaker 4. Note that, in the third embodiment, the same configuration as that in the first embodiment will be denoted by the same reference sign as that in the first embodiment, and will be omitted from description.

In the third embodiment, each of a plurality of divided sound signals is associated with each of a plurality of positions at which a plurality of people are present in a predetermined space. The predetermined space is, for example, the room 100 such as a conference room in which a plurality of people can gather. The predetermined space includes a plurality of positions. For example, each of the plurality of positions is a position at which a person is seated. The room 100 includes a first position 111, a second position 112, a third position 113, and a fourth position 114. Positions at which a plurality of people are seated are not determined. There is one person at one position.

The camera 1 captures an image of a predetermined space including a plurality of positions. The camera 1 is a fixed camera such as a monitoring camera, and is disposed at a position at which an image of all of a plurality of positions can be captured. In the third embodiment, the predetermined space includes four positions, but the present disclosure is not particularly limited to this, and may include two or more positions. In the third embodiment, the camera 1 captures an image of the first position 111, the second position 112, the third position 113, and the fourth position 114.

The sound reproduction device 2B acquires information on a plurality of people in a predetermined space, synchronizes and reproduces a plurality of divided sound signals obtained by dividing a predetermined sound, and outputs, based on the information on the plurality of people, a plurality of divided sound signals to the loudspeaker that emits, to the predetermined space, a plurality of divided sounds converted from the plurality of divided sound signals. The sound reproduction device 2B detects a person present at each of a plurality of positions (the first position 111, the second position 112, the third position 113, and the fourth position 114) in a predetermined space (the room 100) based on an image captured by the camera 1. The sound reproduction device 2B controls volume of each of a plurality of divided sound signals according to a posture of each of a plurality of people. The sound reproduction device 2B changes volume of each of the first divided sound signal to the fourth divided sound signal according to a posture of a person present at each of the first position 111, the second position 112, the third position 113, and the fourth position 114. For example, the sound reproduction device 2B estimates a standing posture and a sitting posture of a person at each of the first position 111, the second position 112, the third position 113, and the fourth position 114.

The sound reproduction device 2B includes at least a computer system including, for example, a control program, a processing circuit such as a processor or a logic circuit that executes the control program, and a recording device such as an internal memory or an accessible external memory that stores the control program. Note that the sound reproduction device 2B may be implemented by, for example, hardware implementation by a processing circuit, execution of a software program held in a memory by a processing circuit or distributed from an external server, or a combination of these hardware implementation and software implementation.

The sound reproduction device 2B includes a person detection part 201B, a feature extraction part 202B, a posture information database 215, a posture estimation part 216, the memory 205, the sound source reproduction part 206, the first volume control part 207, the second volume control part 208, the third volume control part 209, the fourth volume control part 210, and the mixing part 211.

The person detection part 201B detects a person present at each of a plurality of positions in the room 100 based on an image captured by the camera 1. The plurality of positions are determined in advance. Therefore, the person detection part 201B detects a person present in a region corresponding to each of a plurality of positions in an image.

The feature extraction part 202B extracts a feature amount of a body of a person detected by the person detection part 201.

The posture information database 215 stores feature amounts of a plurality of bodies and posture information in association with each other. Here, a method of registering a feature amount of the body of a person in the posture information database 215 will be described. First, an image of a person is captured by a camera. Next, a person is detected from a captured image, and a feature amount of the body of the detected person is extracted. Next, posture information of the person is input by an input device such as a touch panel. Next, the feature amount of the body of the person and the posture information of the person are stored in the posture information database 215 in association with each other.

For example, in a case where a posture in which a person is standing and a posture in which a person is sitting are estimated, a feature amount of the body of the person who is standing and a feature amount of the body of the person who is sitting are extracted. A feature amount of the body of a person who is standing and posture information indicating that the person is in a standing posture are associated with each other, and a feature amount of the body of a person who is sitting and posture information indicating that the person is in a sitting posture are associated with each other, and stored in the posture information database 215.

The posture estimation part 216 outputs a reproduction start instruction for starting reproduction of a predetermined sound to the sound source reproduction part 206. In a case where a person is detected at any of a plurality of positions by the person detection part 201B, the posture estimation part 216 outputs a reproduction start instruction to the sound source reproduction part 206. Further, in a case where a person is no longer detected at any of a plurality of positions by the person detection part 201B, the posture estimation part 216 may output a reproduction end instruction for ending reproduction of a predetermined sound to the sound source reproduction part 206.

Further, the posture estimation part 216 may select a sound corresponding to a current time period from among a plurality of sounds of different types, and output a reproduction start instruction for starting reproduction of the selected sound to the sound source reproduction part 206. For example, the posture estimation part 216 may select a sound corresponding to a current time period from among a first sound corresponding to a time period in the morning (8:00 AM to 12:00 PM), a second sound corresponding to a time period in the afternoon (12:00 PM to 6:00 PM), and a third sound corresponding to a time period in the night (6:00 PM to 10:00 PM). Note that the time period is not limited to the above.

The posture estimation part 216 acquires information on a plurality of people in a predetermined space. The information on a plurality of people includes posture information on a posture of each of the plurality of people. The posture estimation part 216 estimates a posture of each of a plurality of people. The posture estimation part 216 controls volume of each of a plurality of divided sound signals according to posture information of each of a plurality of people.

The posture estimation part 216 compares a feature amount of a body extracted by the feature extraction part 202B with each of feature amounts of a plurality of bodies stored in the posture information database 215. When there is a feature amount that matches a feature amount of a body extracted by the feature extraction part 202B among feature amounts of a plurality of bodies stored in the posture information database 215, the posture estimation part 216 reads posture information associated with the feature amount from the posture information database 215, and estimates a posture of a person from the read posture information.

Note that the posture estimation part 216 may input a feature amount of the body of a person extracted by the feature extraction part 202B to a posture estimation model and acquire a posture of the person from the posture estimation model. The posture estimation model is created by machine learning using a feature amount of the body of a person and a posture of the person as training data. When a feature amount of the body of a person extracted by the feature extraction part 202B is input to the posture estimation model, the posture estimation model outputs a posture of the person.

Posture information in the third embodiment indicates whether or not each of a plurality of people is standing. The posture estimation part 216 estimates whether a person at each of a plurality of positions is in a standing posture or a sitting posture.

Each of a plurality of divided sound signals is associated with each of a plurality of positions at which a plurality of people are present in a predetermined space. The first divided sound signal is associated with the first position 111, the second divided sound signal is associated with the second position 112, the third divided sound signal is associated with the third position 113, and the fourth divided sound signal is associated with the fourth position 114.

The posture estimation part 216 determines volume of the first divided sound signal associated with the first position 111 according to a posture of a person at the first position 111 in the room 100, and sends an instruction to the first volume control part 207 indicating the determined volume. The posture estimation part 216 determines volume of the second divided sound signal associated with the second position 112 according to a posture of a person at the second position 112 in the room 100, and sends an instruction to the second volume control part 208 indicating the determined volume. The posture estimation part 216 determines volume of the third divided sound signal associated with the third position 113 according to a posture of a person at the third position 113 in the room 100, and sends an instruction to the third volume control part 209 indicating the determined volume. The posture estimation part 216 determines volume of the fourth divided sound signal associated with the fourth position 114 according to a posture of a person at the fourth position 114 in the room 100, and sends an instruction to the fourth volume control part 210 indicating the determined volume.

In a case where a person is standing, the posture estimation part 216 determines volume of a divided sound signal to be a predetermined volume. The predetermined volume is, for example, maximum volume. Further, in a case where a person is not standing, the posture estimation part 216 determines volume of a divided sound signal to be zero. Note that, the predetermined volume is not limited to maximum volume, and may be 50% or 80% of maximum volume, and only needs to be larger than 0.

In a case where a person at the first position 111 in the room 100 is standing, the posture estimation part 216 determines volume of the first divided sound signal associated with the first position 111 to be a predetermined volume. Further, in a case where a person at the first position 111 in the room 100 is not standing, that is, in a case where a person at the first position 111 in the room 100 is sitting, the posture estimation part 216 determines volume of the first divided sound signal associated with the first position 111 to be zero.

In a case where a person at the second position 112 in the room 100 is standing, the posture estimation part 216 determines volume of the second divided sound signal associated with the second position 112 to be a predetermined volume. Further, in a case where a person at the second position 112 in the room 100 is not standing, that is, in a case where a person at the second position 112 in the room 100 is sitting, the posture estimation part 216 determines volume of the second divided sound signal associated with the second position 112 to be zero.

In a case where a person at the third position 113 in the room 100 is standing, the posture estimation part 216 determines volume of the third divided sound signal associated with the third position 113 to be a predetermined volume. Further, in a case where a person at the third position 113 in the room 100 is not standing, that is, in a case where a person at the third position 113 in the room 100 is sitting, the posture estimation part 216 determines volume of the third divided sound signal associated with the third position 113 to be zero.

In a case where a person at the fourth position 114 in the room 100 is standing, the posture estimation part 216 determines volume of the fourth divided sound signal associated with the fourth position 114 to be a predetermined volume. Further, in a case where a person at the fourth position 114 in the room 100 is not standing, that is, in a case where a person at the fourth position 114 in the room 100 is sitting, the posture estimation part 216 determines volume of the fourth divided sound signal associated with the fourth position 114 to be zero.

Note that, in a case where there is no person at each position in the room 100, the posture estimation part 216 determines volume of a divided sound signal associated with each position to be zero.

Further, in the third embodiment, the number of a plurality of positions is four, but the present disclosure is not particularly limited to this, and the number of a plurality of positions may be two or more. Further, the number of a plurality of divided sound signals may be the same as or different from the number of a plurality of positions.

Further, in the third embodiment, the posture estimation part 216 estimates a posture in which a person is standing and a posture in which a person is sitting, but the present disclosure is not particularly limited to this, and the posture estimation part 216 may be configured to estimate only a posture in which a person is standing. That is, the posture estimation part 216 may determine volume of a divided sound signal to be a predetermined volume in a case where a posture of a person is a standing posture, and may determine volume of a divided sound signal to be zero in a case where a posture of a person is not a standing posture.

When a reproduction start instruction is input from the posture estimation part 216, the sound source reproduction part 206 starts reproduction of a plurality of divided sound signals obtained by dividing the predetermined sound. Further, when a reproduction end instruction is input from the posture estimation part 216, the sound source reproduction part 206 ends reproduction of a plurality of divided sound signals obtained by dividing the predetermined sound.

The sound source reproduction part 206 synchronizes and reproduces all of the first divided sound signal to the fourth divided sound signal regardless of whether or not a person is present at the first position 111 to the fourth position 114 in the room 100. That is, when a person is detected at at least one of the first position 111 to the fourth position 114, the sound source reproduction part 206 synchronizes and reproduces all of the first divided sound signal to the fourth divided sound signal.

The first volume control part 207 to the fourth volume control part 210 control volume of each of a plurality of divided sound signals according to a posture of each of a plurality of people.

The first volume control part 207 controls volume of the first divided sound signal according to a posture of a person at the first position 111. That is, the first volume control part 207 controls volume of the first divided sound signal according to whether or not a person at the first position 111 is standing. The first volume control part 207 sets volume of the first divided sound signal input from the sound source reproduction part 206 to the volume instructed by the posture estimation part 216.

The second volume control part 208 controls volume of the second divided sound signal according to a posture of a person at the second position 112. That is, the second volume control part 208 controls volume of the second divided sound signal according to whether or not a person at the second position 112 is standing. The second volume control part 208 sets volume of the second divided sound signal input from the sound source reproduction part 206 to the volume instructed by the posture estimation part 216.

The third volume control part 209 controls volume of the third divided sound signal according to a posture of a person at the third position 113. That is, the third volume control part 209 controls volume of the third divided sound signal according to whether or not a person at the third position 113 is standing. The third volume control part 209 sets volume of the third divided sound signal input from the sound source reproduction part 206 to the volume instructed by the posture estimation part 216.

The fourth volume control part 210 controls volume of the fourth divided sound signal according to a posture of a person at the fourth position 114. That is, the fourth volume control part 210 controls volume of the fourth divided sound signal according to whether or not a person at the fourth position 114 is standing. The fourth volume control part 210 sets volume of the fourth divided sound signal input from the sound source reproduction part 206 to the volume instructed by the posture estimation part 216.

Next, sound reproduction processing by the sound reproduction device 2B according to the third embodiment of the present disclosure will be described.

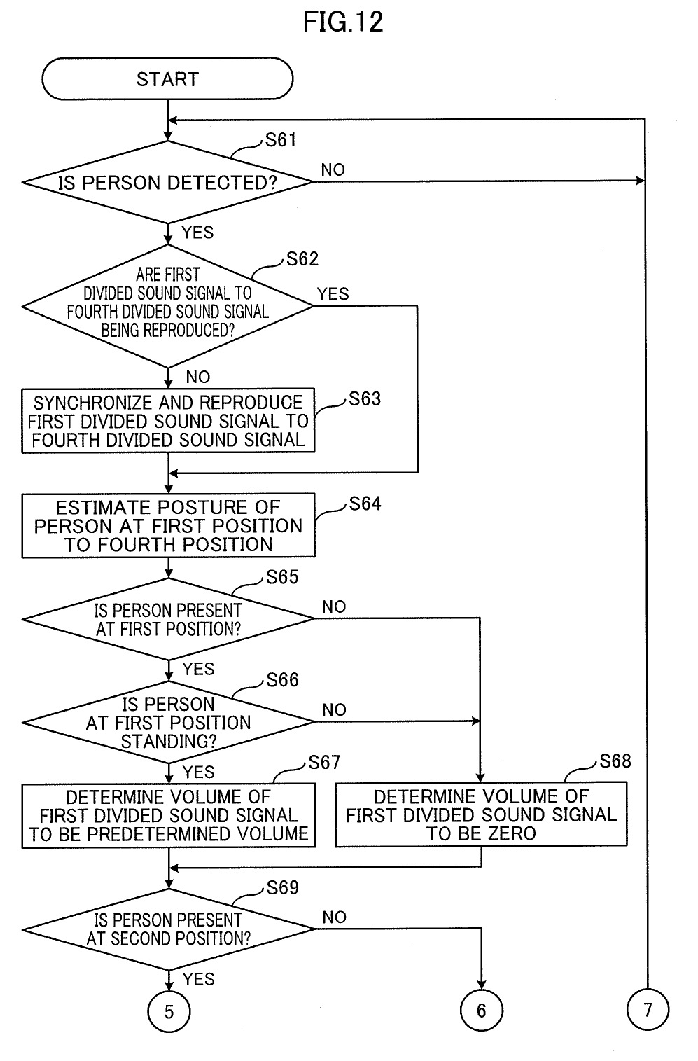

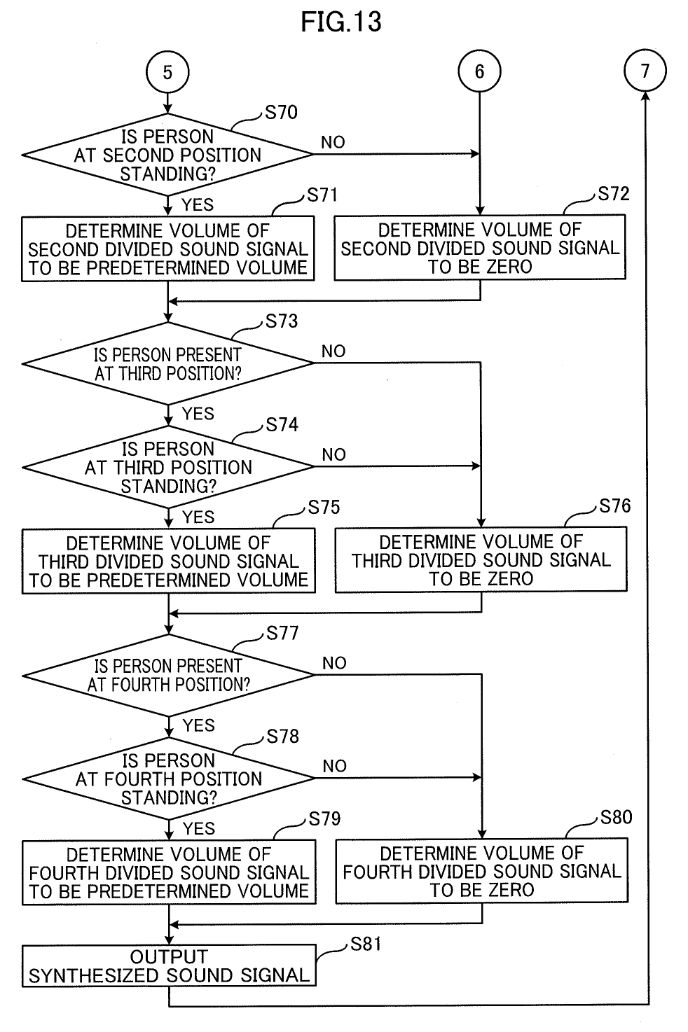

FIG. 12 is a first flowchart for explaining sound reproduction processing by the sound reproduction device 2B in the third embodiment of the present disclosure, and FIG. 13 is a second flowchart for explaining sound reproduction processing by the sound reproduction device 2B in the third embodiment of the present disclosure.

First, in Step S61, the posture estimation part 216 determines whether or not a person is detected at any of a plurality of positions by the person detection part 201B. Here, in a case where it is determined that no person is detected at any of the plurality of positions (NO in Step S61), the determination processing in Step S61 is repeatedly performed.

On the other hand, in a case where it is determined that a person is detected at any of the plurality of positions (YES in Step S61), in Step S62, the posture estimation part 216 determines whether or not the first to fourth divided sound signals obtained by dividing a predetermined sound are being reproduced.

Here, when it is determined that the first to fourth divided sound signals are being reproduced (YES in Step S62), the processing proceeds to Step S64.

On the other hand, in a case where it is determined that the first divided sound signal to the fourth divided sound signal are not being reproduced (NO in Step S62), the sound source reproduction part 206 synchronizes and reproduces the first divided sound signal to the fourth divided sound signal obtained by dividing a predetermined sound in Step S63. At this time, the posture estimation part 216 outputs a reproduction start instruction for starting reproduction of a predetermined sound to the sound source reproduction part 206. When the reproduction start instruction is input from the posture estimation part 216, the sound source reproduction part 206 reads the first divided sound signal to the fourth divided sound signal from the memory 205, and synchronizes and reproduces the read first divided sound signal to fourth divided sound signal. The sound source reproduction part 206 outputs the reproduced first divided sound signal to fourth divided sound signal to the first volume control part 207 to the fourth volume control part 210, respectively.

Next, in Step S64, the posture estimation part 216 estimates postures of people at the first position 111 to the fourth position 114 in the room 100 based on an image captured by the camera 1. More specifically, the posture estimation part 216 estimates whether or not people at the first position 111 to the fourth position 114 in the room 100 are standing.

The person detection part 201B detects people at the first position 111 to the fourth position 114 from an image captured by the camera 1. The feature extraction part 202B extracts a feature amount of the body of a person detected by the person detection part 201B. The posture estimation part 216 compares a feature amount of a body extracted by the feature extraction part 202B with each of feature amounts of a plurality of bodies stored in the posture information database 215. When there is a feature amount that matches a feature amount of a body extracted by the feature extraction part 202B among feature amounts of a plurality of bodies stored in the posture information database 215, the posture estimation part 216 reads posture information associated with the feature amount from the posture information database 215, and estimates a posture of a person from the read posture information.

Next, in Step S65, the posture estimation part 216 determines whether or not there is a person at the first position 111 in the room 100.

Here, in a case where it is determined that there is no person at the first position 111 (NO in Step S65), the processing proceeds to Step S68.

On the other hand, in a case where it is determined that a person is present at the first position 111 (YES in Step S65), in Step S66, the posture estimation part 216 determines whether or not the person present at the first position 111 in the room 100 is standing.

Here, in a case where it is determined that the person at the first position 111 is standing (YES in Step S66), in Step S67, the posture estimation part 216 determines volume of the first divided sound signal associated with the first position 111 to be a predetermined volume. The predetermined volume is, for example, maximum volume. The posture estimation part 216 sends an instruction to the first volume control part 207 indicating the volume of the first divided sound signal determined to be the predetermined volume. The first volume control part 207 sets volume of the first divided sound signal to the predetermined volume based on the instruction from the posture estimation part 216. The first volume control part 207 outputs the first divided sound signal with set volume to the mixing part 211.

On the other hand, in a case where it is determined that the person at the first position 111 is not standing, that is, in a case where it is determined that the person at the first position 111 is sitting (NO in Step S66), in Step S68, the posture estimation part 216 determines volume of the first divided sound signal associated with the first position 111 to be zero. The posture estimation part 216 sends an instruction to the first volume control part 207 indicating the volume of the first divided sound signal determined to be zero. The first volume control part 207 sets volume of the first divided sound signal to zero based on the instruction from the posture estimation part 216. The first volume control part 207 outputs the first divided sound signal with set volume to the mixing part 211.

Next, in Step S69, the posture estimation part 216 determines whether or not there is a person at the second position 112 in the room 100.

Here, in a case where it is determined that there is no person at the second position 112 (NO in Step S69), the processing proceeds to Step S72.

On the other hand, in a case where it is determined that a person is present at the second position 112 (YES in Step S69), in Step S70, the posture estimation part 216 determines whether or not the person present at the second position 112 in the room 100 is standing.

Here, in a case where it is determined that the person at the second position 112 is standing (YES in Step S70), in Step S71, the posture estimation part 216 determines volume of the second divided sound signal associated with the second position 112 to be a predetermined volume. The predetermined volume is, for example, maximum volume. The posture estimation part 216 sends an instruction to the second volume control part 208 indicating the volume of the second divided sound signal determined to be the predetermined volume. The second volume control part 208 sets volume of the second divided sound signal to the predetermined volume based on the instruction from the posture estimation part 216. The second volume control part 208 outputs the second divided sound signal with set volume to the mixing part 211.

On the other hand, in a case where it is determined that the person at the second position 112 is not standing, that is, in a case where it is determined that the person at the second position 112 is sitting (NO in Step S70), in Step S72, the posture estimation part 216 determines volume of the second divided sound signal associated with the second position 112 to be zero. The posture estimation part 216 sends an instruction to the second volume control part 208 indicating the volume of the second divided sound signal determined to be zero. The second volume control part 208 sets volume of the second divided sound signal to zero based on the instruction from the posture estimation part 216. The second volume control part 208 outputs the second divided sound signal with set volume to the mixing part 211.

Next, in Step S73, the posture estimation part 216 determines whether or not there is a person at the third position 113 in the room 100.

Here, in a case where it is determined that there is no person at the third position 113 (NO in Step S73), the processing proceeds to Step S76.

On the other hand, in a case where it is determined that a person is present at the third position 113 (YES in Step S73), in Step S74, the posture estimation part 216 determines whether or not the person present at the third position 113 in the room 100 is standing.

Here, in a case where it is determined that the person at the third position 113 is standing (YES in Step S74), in Step S75, the posture estimation part 216 determines volume of the third divided sound signal associated with the third position 113 to be a predetermined volume. The predetermined volume is, for example, maximum volume. The posture estimation part 216 sends an instruction to the third volume control part 209 indicating the volume of the third divided sound signal determined to be the predetermined volume. The third volume control part 209 sets volume of the third divided sound signal to the predetermined volume based on the instruction from the posture estimation part 216. The third volume control part 209 outputs the third divided sound signal with set volume to the mixing part 211.

On the other hand, in a case where it is determined that the person at the third position 113 is not standing, that is, in a case where it is determined that the person at the third position 113 is sitting (NO in Step S74), in Step S76, the posture estimation part 216 determines volume of the third divided sound signal associated with the third position 113 to be zero. The posture estimation part 216 sends an instruction to the third volume control part 209 indicating the volume of the third divided sound signal determined to be zero. The third volume control part 209 sets volume of the third divided sound signal to zero based on the instruction from the posture estimation part 216. The third volume control part 209 outputs the third divided sound signal with set volume to the mixing part 211.

Next, in Step S77, the posture estimation part 216 determines whether or not there is a person at the fourth position 114 in the room 100.

Here, in a case where it is determined that there is no person at the fourth position 114 (NO in Step S77), the processing proceeds to Step S80.

On the other hand, in a case where it is determined that a person is present at the fourth position 114 (YES in Step S77), in Step S78, the posture estimation part 216 determines whether or not the person present at the fourth position 114 in the room 100 is standing.

Here, in a case where it is determined that the person at the fourth position 114 is standing (YES in Step S78), in Step S79, the posture estimation part 216 determines volume of the fourth divided sound signal associated with the fourth position 114 to be a predetermined volume. The predetermined volume is, for example, maximum volume. The posture estimation part 216 sends an instruction to the fourth volume control part 210 indicating the volume of the fourth divided sound signal determined to be the predetermined volume. The fourth volume control part 210 sets volume of the fourth divided sound signal to the predetermined volume based on the instruction from the posture estimation part 216. The fourth volume control part 210 outputs the fourth divided sound signal with set volume to the mixing part 211.

On the other hand, in a case where it is determined that the person at the fourth position 114 is not standing, that is, in a case where it is determined that the person at the fourth position 114 is sitting (NO in Step S78), in Step S80, the posture estimation part 216 determines volume of the fourth divided sound signal associated with the fourth position 114 to be zero. The posture estimation part 216 sends an instruction to the fourth volume control part 210 indicating the volume of the fourth divided sound signal determined to be zero. The fourth volume control part 210 sets volume of the fourth divided sound signal to zero based on the instruction from the posture estimation part 216. The fourth volume control part 210 outputs the fourth divided sound signal with set volume to the mixing part 211.

Next, in Step S81, the mixing part 211 outputs a synthesized sound signal obtained by synthesizing the first divided sound signal to the fourth divided sound signal with set volume to the amplifier 3. The amplifier 3 amplifies the synthesized sound signal and outputs the amplified synthesized sound signal to the loudspeaker 4. The loudspeaker 4 converts the synthesized sound signal into a synthesized sound, and emits, into the room 100, a synthesized sound obtained by synthesizing the first divided sound to the fourth divided sound to which the first volume control part 207 to the fourth volume control part 210 set respective volumes.

By the above, when the person at the first position 111 is standing, the first divided sound with a predetermined volume is output from the loudspeaker 4, and when the person at the first position 111 is sitting, the first divided sound is not output from the loudspeaker 4. Further, when the person at the second position 112 is standing, the second divided sound with a predetermined volume is output from the loudspeaker 4, and when the person at the second position 112 is sitting, the second divided sound is not output from the loudspeaker 4. Further, when the person at the third position 113 is standing, the third divided sound with a predetermined volume is output from the loudspeaker 4, and when the person at the third position 113 is sitting, the third divided sound is not output from the loudspeaker 4. Further, when the person at the fourth position 114 is standing, the fourth divided sound with a predetermined volume is output from the loudspeaker 4, and when the person at the fourth position 114 is sitting, the fourth divided sound is not output from the loudspeaker 4.

As described above, if a person at each position is standing, volume of a divided sound can be increased to make a predetermined space an environment in which a plurality of people can easily gather, and if a person at each position is sitting, volume of a divided sound can be decreased to make a predetermined space an environment in which it is easy to have a conversation.

Note that, in the third embodiment, a posture of a person in a predetermined space is estimated based on a feature amount of the body of the person extracted from an image captured by the camera 1, but the present disclosure is not particularly limited to this, and other estimation methods may be used. For example, a posture of a person may be estimated using a distance measured by an ultrasonic sensor, a posture of a person may be estimated using a distance or a shape measured by a laser sensor such as Light Detection And Ranging (LiDAR), a posture of a person may be estimated using acceleration measured by an acceleration sensor, a posture of a person may be estimated using a pressure value measured by a pressure sensor, or a posture of a person may be estimated using a distance measured by an infrared sensor.

### Fourth embodiment

In the sound reproduction device described in a fourth embodiment, posture information related to a posture of each of a plurality of people is acquired, and volume of each of a plurality of divided sound signals is controlled according to the posture information of each of the plurality of people. Posture information in the fourth embodiment indicates whether or not each of a plurality of people is sitting at each of a plurality of positions in a predetermined space, and indicates whether or not at least one of the plurality of people is in a posture of feeling drowsy.

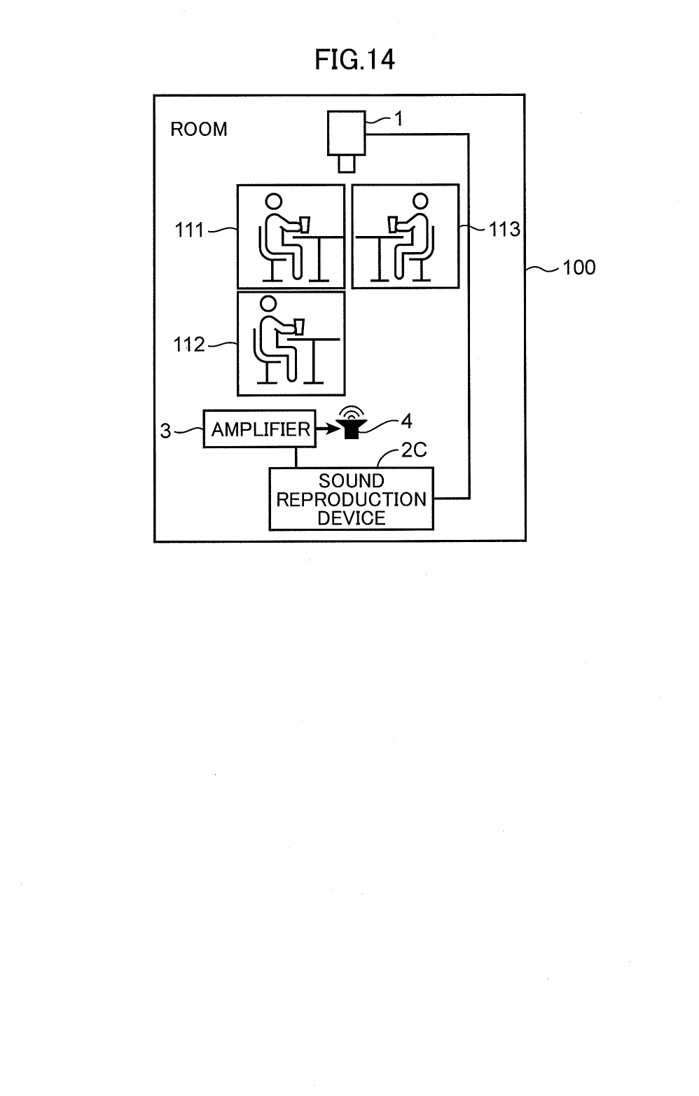

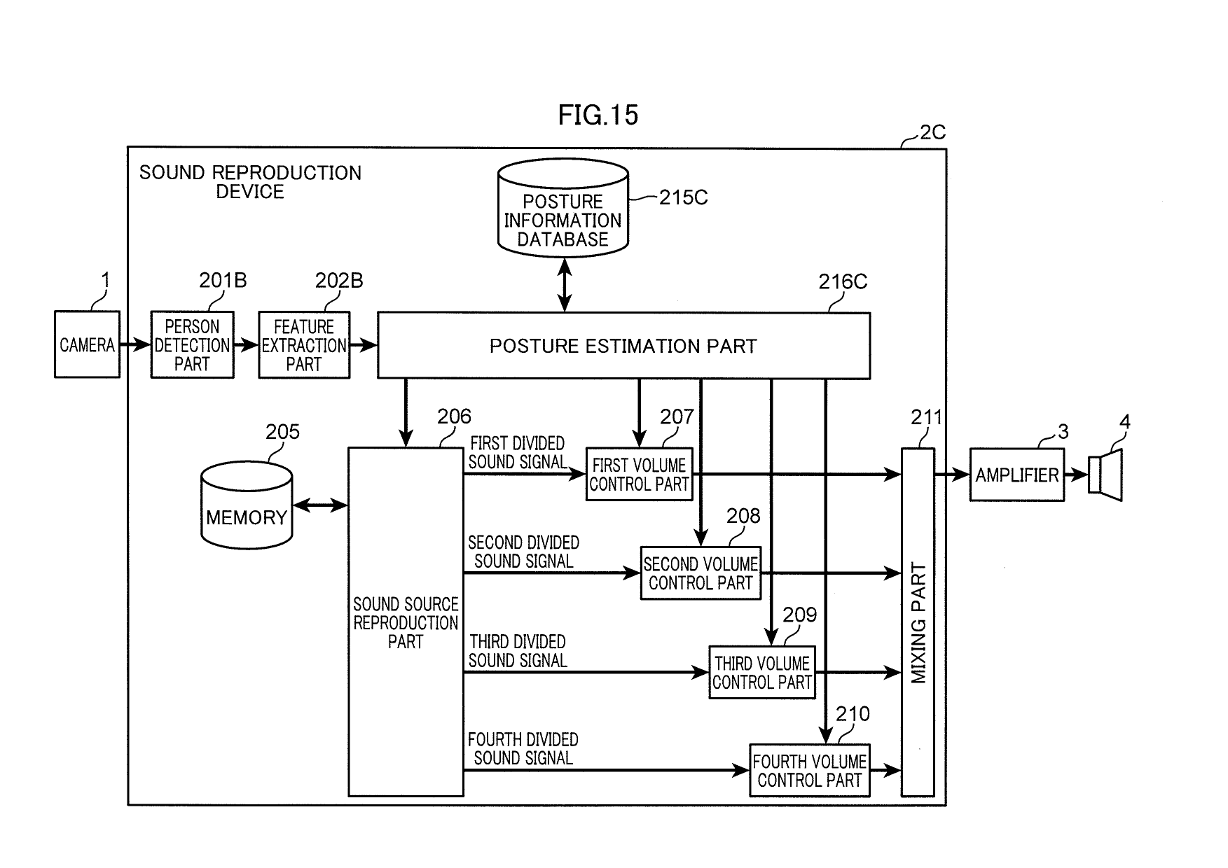

FIG. 14 is a diagram illustrating an overall configuration of the sound reproduction system according to the fourth embodiment, and FIG. 15 is a block diagram illustrating a configuration of a sound reproduction device 2C according to the fourth embodiment.

The sound reproduction system according to the fourth embodiment includes the camera 1, a sound reproduction device 2C, the amplifier 3, and the loudspeaker 4. Note that, in the fourth embodiment, the same configurations as those in the first and third embodiments will be denoted by the same reference signs as those in the first and third embodiments, and will be omitted from description.

In the fourth embodiment, the predetermined space is, for example, the room 100 such as a conference room in which a plurality of people can gather. The predetermined space includes a plurality of positions. For example, each of the plurality of positions is a position at which a person is seated. The room 100 includes the first position 111, the second position 112, and the third position 113. Positions at which a plurality of people are seated are not determined. There is one person at one position.

In the fourth embodiment, the predetermined space includes three positions, but the present disclosure is not particularly limited to this, and may include two or more positions. In the fourth embodiment, the camera 1 captures an image of the first position 111, the second position 112, and the third position 113.

The sound reproduction device 2C acquires information on a plurality of people in a predetermined space, synchronizes and reproduces a plurality of divided sound signals obtained by dividing a predetermined sound, and outputs, based on the information on the plurality of people, a plurality of divided sound signals to the loudspeaker 4 that emits, to the predetermined space, a plurality of divided sounds converted from the plurality of divided sound signals. The sound reproduction device 2C detects a person present at each of a plurality of positions (the first position 111, the second position 112, and the third position 113) in a predetermined space (the room 100) based on an image captured by the camera 1. The sound reproduction device 2C controls volume of each of a plurality of divided sound signals according to a posture of each of a plurality of people. The sound reproduction device 2C changes volume of each of the first divided sound signal to the fourth divided sound signal according to a posture of a person present at each of the first position 111, the second position 112, and the third position 113. For example, the sound reproduction device 2C estimates a standing posture, a sitting posture, and a posture of feeling drowsy of a person at each of the first position 111, the second position 112, and the third position 113.

The sound reproduction device 2C includes at least a computer system including, for example, a control program, a processing circuit such as a processor or a logic circuit that executes the control program, and a recording device such as an internal memory or an accessible external memory that stores the control program. Note that the sound reproduction device 2C may be implemented by, for example, hardware implementation by a processing circuit, execution of a software program held in a memory by a processing circuit or distributed from an external server, or a combination of these hardware implementation and software implementation.

The sound reproduction device 2C includes a person detection part 201B, a feature extraction part 202B, a posture information database 215C, a posture estimation part 216C, the memory 205, the sound source reproduction part 206, the first volume control part 207, the second volume control part 208, the third volume control part 209, the fourth volume control part 210, and the mixing part 211.

The posture information database 215C stores feature amounts of a plurality of bodies and posture information in association with each other. Here, a method of registering a feature amount of the body of a person in the posture information database 215C will be described. First, an image of a person is captured by a camera. Next, a person is detected from a captured image, and a feature amount of the body of the detected person is extracted. Next, posture information of the person is input by an input device such as a touch panel. Next, the feature amount of the body of the person and the posture information of the person are stored in the posture information database 215C in association with each other.

For example, in a case where a posture in which a person is standing, a posture in which a person is sitting, and a posture in which a person is feeling drowsy are estimated, a feature amount of the body of a person who is standing, a feature amount of the body of a person who is sitting, and a feature amount of the body of a person who is feeling drowsy are extracted. A feature amount of the body of a person who is standing and posture information indicating that the person is in a standing posture are associated with each other, and a feature amount of the body of a person who is sitting and posture information indicating that the person is in a sitting posture are associated with each other, and stored in the posture information database 215C. Further, a feature amount of the body of a person who is feeling drowsy and posture information indicating that the person is in a posture of feeling drowsy are associated with each other and stored in the posture information database 215C.

A posture in which a person is feeling drowsy includes a posture in which the back of a sitting person is rounded, a posture in which the head is moving back and forth, a posture in which a person yawns at a high frequency, a posture in which a person rubs the eyes at a high frequency, or a posture in which a person blinks at a high frequency.

The posture estimation part 216C outputs a reproduction start instruction for starting reproduction of a predetermined sound to the sound source reproduction part 206. In a case where a person is detected at any of a plurality of positions by the person detection part 201B, the posture estimation part 216C outputs a reproduction start instruction to the sound source reproduction part 206. Further, in a case where a person is no longer detected at any of a plurality of positions by the person detection part 201B, the posture estimation part 216C may output a reproduction end instruction for ending reproduction of a predetermined sound to the sound source reproduction part 206.

Further, the posture estimation part 216C may select a sound corresponding to a current time period from among a plurality of sounds of different types, and output a reproduction start instruction for starting reproduction of the selected sound to the sound source reproduction part 206. For example, the posture estimation part 216C may select a sound corresponding to a current time period from among a first sound corresponding to a time period in the morning (8:00 AM to 12:00 PM), a second sound corresponding to a time period in the afternoon (12:00 PM to 6:00 PM), and a third sound corresponding to a time period in the night (6:00 PM to 10:00 PM). Note that the time period is not limited to the above.

The posture estimation part 216C acquires information on a plurality of people in a predetermined space. The information on a plurality of people includes posture information on a posture of each of the plurality of people. The posture estimation part 216C estimates a posture of each of a plurality of people. The posture estimation part 216C controls volume of each of a plurality of divided sound signals according to posture information of each of a plurality of people.

The posture estimation part 216C compares a feature amount of a body extracted by the feature extraction part 202B with each of feature amounts of a plurality of bodies stored in the posture information database 215C. When there is a feature amount that matches a feature amount of a body extracted by the feature extraction part 202B among feature amounts of a plurality of bodies stored in the posture information database 215C, the posture estimation part 216C reads posture information associated with the feature amount from the posture information database 215C, and estimates a posture of a person from the read posture information.

Note that the posture estimation part 216C may input a feature amount of the body of a person extracted by the feature extraction part 202B to a posture estimation model and acquire a posture of the person from the posture estimation model. The posture estimation model is created by machine learning using a feature amount of the body of a person and a posture of the person as training data. When a feature amount of the body of a person extracted by the feature extraction part 202B is input to the posture estimation model, the posture estimation model outputs a posture of the person.

Posture information in the fourth embodiment indicates whether or not each of a plurality of people is sitting at each of a plurality of positions in a predetermined space, and indicates whether or not at least one of the plurality of people is in a posture of feeling drowsy. The posture estimation part 216C estimates whether a person at each of a plurality of positions is in a standing posture or a sitting posture. Further, the posture estimation part 216C estimates whether at least one of a plurality of people is in a posture of feeling drowsy.

Each of a plurality of divided sound signals is associated with each of a plurality of positions at which a plurality of people are present in a predetermined space. The first divided sound signal is associated with the first position 111, the second divided sound signal is associated with the second position 112, and the third divided sound signal is associated with the third position 113.

The posture estimation part 216C determines volume of the first divided sound signal associated with the first position 111 according to a posture of a person at the first position 111 in the room 100, and sends an instruction to the first volume control part 207 indicating the determined volume. The posture estimation part 216C determines volume of the second divided sound signal associated with the second position 112 according to a posture of a person at the second position 112 in the room 100, and sends an instruction to the second volume control part 208 indicating the determined volume. The posture estimation part 216C determines volume of the third divided sound signal associated with the third position 113 according to a posture of a person at the third position 113 in the room 100, and sends an instruction to the third volume control part 209 indicating the determined volume. The posture estimation part 216C determines volume of the fourth divided sound signal according to a posture of a person at the first position 111 to the third position 113 in the room 100, and sends an instruction to the fourth volume control part 210 indicating the determined volume.

In a case where a person is sitting, the posture estimation part 216C determines volume of a divided sound signal associated with a position where the person is sitting to be a predetermined volume. The predetermined volume is, for example, maximum volume. Further, in a case where a person is not sitting, the posture estimation part 216C determines volume of a divided sound signal associated with a position where the person is not sitting to be zero. Further, in a case where at least one of a plurality of people is in a posture of feeling drowsy, the posture estimation part 216C determines volume of a different divided sound signal for suppressing drowsiness different from a plurality of divided sound signals associated with each of a plurality of positions to be a predetermined volume. Further, in a case where all of a plurality of people are not in a posture of feeling drowsy, the posture estimation part 216C determines volume of the different divided sound signal to be zero. Note that, the predetermined volume is not limited to maximum volume, and may be 50% or 80% of maximum volume, and only needs to be larger than 0.

In a case where a person at the first position 111 in the room 100 is sitting, the posture estimation part 216C determines volume of the first divided sound signal associated with the first position 111 to be a predetermined volume. Further, in a case where a person at the first position 111 in the room 100 is not sitting, that is, in a case where a person at the first position 111 in the room 100 is standing, the posture estimation part 216C determines volume of the first divided sound signal associated with the first position 111 to be zero.

In a case where a person at the second position 112 in the room 100 is sitting, the posture estimation part 216C determines volume of the second divided sound signal associated with the second position 112 to be a predetermined volume. Further, in a case where a person at the second position 112 in the room 100 is not sitting, that is, in a case where a person at the second position 112 in the room 100 is standing, the posture estimation part 216C determines volume of the second divided sound signal associated with the second position 112 to be zero.

In a case where a person at the third position 113 in the room 100 is sitting, the posture estimation part 216C determines volume of the third divided sound signal associated with the third position 113 to be a predetermined volume. Further, in a case where a person at the third position 113 in the room 100 is not sitting, that is, in a case where a person at the third position 113 in the room 100 is standing, the posture estimation part 216C determines volume of the third divided sound signal associated with the third position 113 to be zero.

In a case where at least one person at the first position 111 to the third position 113 in the room 100 is feeling drowsy, the posture estimation part 216C determines volume of the fourth divided sound signal for suppressing drowsiness to be a predetermined volume. Further, in a case where all people at the first position 111 to the third position 113 in the room 100 are not feeling drowsy, the posture estimation part 216C determines volume of the fourth divided sound signal to be zero.

The fourth divided sound signal for suppressing drowsiness includes a sound brighter than the first to third divided sound signals, a sound of a percussion instrument having appropriate rhythm, or a sound effect for attracting attention of a person. Further, the posture estimation part 216C may make a predetermined volume of the fourth divided sound signal larger than a predetermined volume of the first to third divided sound signals.

Note that, in a case where there is no person at each position in the room 100, the posture estimation part 216C determines volume of a divided sound signal associated with each position to be zero.

Further, in the fourth embodiment, the number of a plurality of positions is three, but the present disclosure is not particularly limited to this, and the number of a plurality of positions may be two or more.

Further, in the fourth embodiment, the posture estimation part 216C estimates a posture in which a person is sitting, a posture in which a person is standing, and a posture in which a person is feeling drowsy, but the present disclosure is not particularly limited to this, and the posture estimation part 216C may estimate the posture in which a person is sitting and the posture in which a person is feeling drowsy. That is, the posture estimation part 216C may determine volume of a divided sound signal to be a predetermined volume in a case where a posture of a person is a sitting posture, and may determine volume of a divided sound signal to be zero in a case where a posture of a person is not a sitting posture.

The first volume control part 207 to the fourth volume control part 210 control volume of each of a plurality of divided sound signals according to a posture of each of a plurality of people.

The first volume control part 207 controls volume of the first divided sound signal according to a posture of a person at the first position 111. That is, the first volume control part 207 controls volume of the first divided sound signal according to whether or not a person at the first position 111 is sitting. The first volume control part 207 sets volume of the first divided sound signal input from the sound source reproduction part 206 to the volume instructed by the posture estimation part 216C.

The second volume control part 208 controls volume of the second divided sound signal according to a posture of a person at the second position 112. That is, the second volume control part 208 controls volume of the second divided sound signal according to whether or not a person at the second position 112 is sitting. The second volume control part 208 sets volume of the second divided sound signal input from the sound source reproduction part 206 to the volume instructed by the posture estimation part 216C.

The third volume control part 209 controls volume of the third divided sound signal according to a posture of a person at the third position 113. That is, the third volume control part 209 controls volume of the third divided sound signal according to whether or not a person at the third position 113 is sitting. The third volume control part 209 sets volume of the third divided sound signal input from the sound source reproduction part 206 to the volume instructed by the posture estimation part 216C.

The fourth volume control part 210 controls volume of the fourth divided sound signal according to a posture of at least one person present at the first position 111 to the third position 113. That is, the fourth volume control part 210 controls volume of the fourth divided sound signal according to whether or not at least one person at the first position 111 to the third position 113 is feeling drowsy. The fourth volume control part 210 sets volume of the fourth divided sound signal input from the sound source reproduction part 206 to the volume instructed by the posture estimation part 216C.

Next, sound reproduction processing by the sound reproduction device 2C according to the fourth embodiment of the present disclosure will be described.

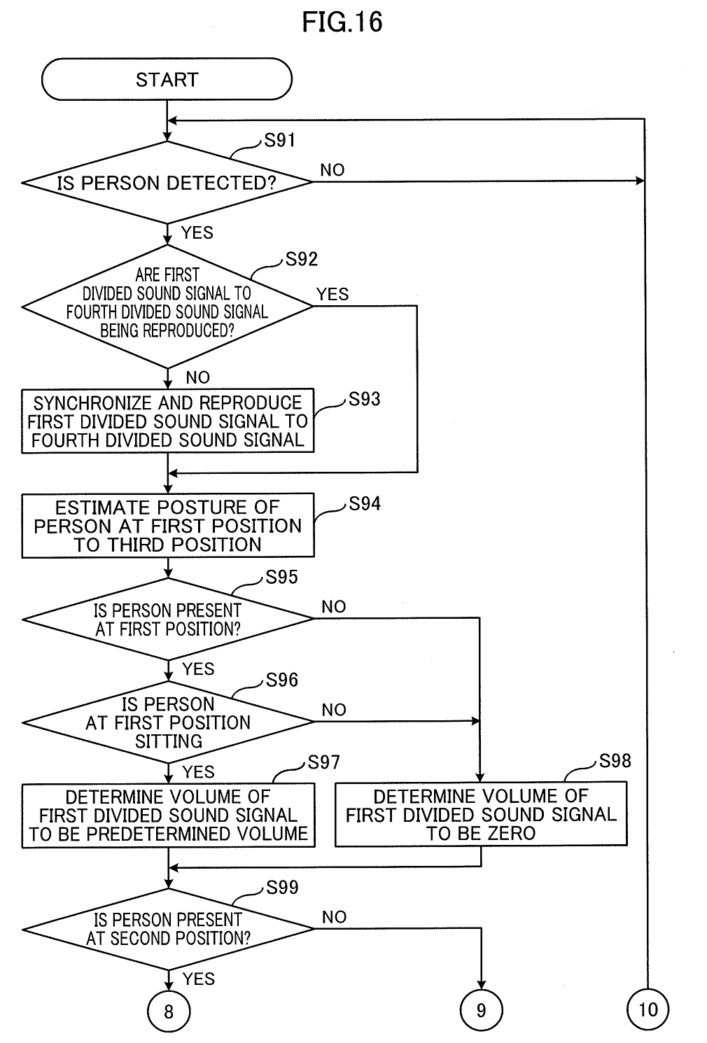

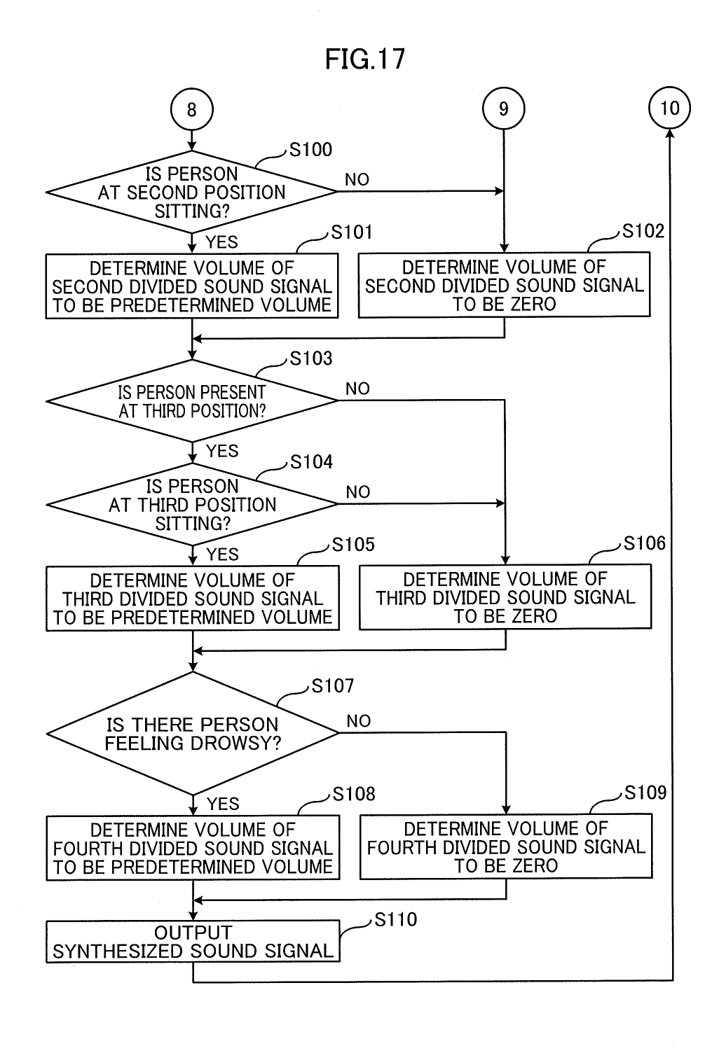

FIG. 16 is a first flowchart for explaining sound reproduction processing by the sound reproduction device 2C in the fourth embodiment of the present disclosure, and FIG. 17 is a second flowchart for explaining sound reproduction processing by the sound reproduction device 2C in the fourth embodiment of the present disclosure.

The processing of Steps S91 to S93 is the same as the processing of Steps S61 to S63 illustrated in FIG. 12, and will be omitted from description.

Next, in Step S94, the posture estimation part 216C estimates postures of people at the first position 111 to the third position 113 in the room 100 based on an image captured by the camera 1. More specifically, the posture estimation part 216C estimates whether or not people at the first position 111 to the third position 113 in the room 100 are sitting, and estimates whether or not the people at the first position 111 to the third position 113 in the room 100 are feeling drowsy.

Next, in Step S95, the posture estimation part 216C determines whether or not there is a person at the first position 111 in the room 100.

Here, in a case where it is determined that there is no person at the first position 111 (NO in Step S95), the processing proceeds to Step S98.

On the other hand, in a case where it is determined that a person is present at the first position 111 (YES in Step S95), in Step S96, the posture estimation part 216C determines whether or not the person present at the first position 111 in the room 100 is sitting.

Here, in a case where it is determined that the person at the first position 111 is sitting (YES in Step S96), in Step S97, the posture estimation part 216C determines volume of the first divided sound signal associated with the first position 111 to be a predetermined volume. The predetermined volume is, for example, maximum volume. The posture estimation part 216C sends an instruction to the first volume control part 207 indicating the volume of the first divided sound signal determined to be the predetermined volume. The first volume control part 207 sets volume of the first divided sound signal to the predetermined volume based on the instruction from the posture estimation part 216C. The first volume control part 207 outputs the first divided sound signal with set volume to the mixing part 211.

On the other hand, in a case where it is determined that the person at the first position 111 is not sitting, that is, in a case where it is determined that the person at the first position 111 is standing (NO in Step S96), in Step S98, the posture estimation part 216C determines volume of the first divided sound signal associated with the first position 111 to be zero. The posture estimation part 216C sends an instruction to the first volume control part 207 indicating the volume of the first divided sound signal determined to be zero. The first volume control part 207 sets volume of the first divided sound signal to zero based on the instruction from the posture estimation part 216C. The first volume control part 207 outputs the first divided sound signal with set volume to the mixing part 211.

Next, in Step S99, the posture estimation part 216C determines whether or not there is a person at the second position 112 in the room 100.

Here, in a case where it is determined that there is no person at the second position 112 (NO in Step S99), the processing proceeds to Step S102.

On the other hand, in a case where it is determined that a person is present at the second position 112 (YES in Step S99), in Step S100, the posture estimation part 216C determines whether or not the person present at the second position 112 in the room 100 is sitting.

Here, in a case where it is determined that the person at the second position 112 is sitting (YES in Step S100), in Step S101, the posture estimation part 216C determines volume of the second divided sound signal associated with the second position 112 to be a predetermined volume. The predetermined volume is, for example, maximum volume. The posture estimation part 216C sends an instruction to the second volume control part 208 indicating the volume of the second divided sound signal determined to be the predetermined volume. The second volume control part 208 sets volume of the second divided sound signal to the predetermined volume based on the instruction from the posture estimation part 216C. The second volume control part 208 outputs the second divided sound signal with set volume to the mixing part 211.

On the other hand, in a case where it is determined that the person at the second position 112 is not sitting, that is, in a case where it is determined that the person at the second position 112 is standing (NO in Step S100), in Step S102, the posture estimation part 216C determines volume of the second divided sound signal associated with the second position 112 to be zero. The posture estimation part 216C sends an instruction to the second volume control part 208 indicating the volume of the second divided sound signal determined to be zero. The second volume control part 208 sets volume of the second divided sound signal to zero based on the instruction from the posture estimation part 216C. The second volume control part 208 outputs the second divided sound signal with set volume to the mixing part 211.

Next, in Step S103, the posture estimation part 216C determines whether or not there is a person at the third position 113 in the room 100.

Here, in a case where it is determined that there is no person at the third position 113 (NO in Step S103), the processing proceeds to Step S106.

On the other hand, in a case where it is determined that a person is present at the third position 113 (YES in Step S103), in Step S104, the posture estimation part 216C determines whether or not the person present at the third position 113 in the room 100 is sitting.

Here, in a case where it is determined that the person at the third position 113 is sitting (YES in Step S104), in Step S105, the posture estimation part 216C determines volume of the third divided sound signal associated with the third position 113 to be a predetermined volume. The predetermined volume is, for example, maximum volume. The posture estimation part 216C sends an instruction to the third volume control part 209 indicating the volume of the third divided sound signal determined to be the predetermined volume. The third volume control part 209 sets volume of the third divided sound signal to the predetermined volume based on the instruction from the posture estimation part 216C. The third volume control part 209 outputs the third divided sound signal with set volume to the mixing part 211.

On the other hand, in a case where it is determined that the person at the third position 113 is not sitting, that is, in a case where it is determined that the person at the third position 113 is standing (NO in Step S104), in Step S106, the posture estimation part 216C determines volume of the third divided sound signal associated with the third position 113 to be zero. The posture estimation part 216C sends an instruction to the third volume control part 209 indicating the volume of the third divided sound signal determined to be zero. The third volume control part 209 sets volume of the third divided sound signal to zero based on the instruction from the posture estimation part 216C. The third volume control part 209 outputs the third divided sound signal with set volume to the mixing part 211.

Next, in Step S107, the posture estimation part 216C determines whether or not there is a person who is feeling drowsy at the first position 111 to the third position 113 in the room 100.

Here, in a case where it is determined that there is a person who is feeling drowsy at the first position 111 to the third position 113 (YES in Step S107), in Step S108, the posture estimation part 216C determines volume of the fourth divided sound signal for suppressing drowsiness to be a predetermined volume. The predetermined volume is, for example, maximum volume. The posture estimation part 216C sends an instruction to the fourth volume control part 210 indicating the volume of the fourth divided sound signal determined to be the predetermined volume. The fourth volume control part 210 sets volume of the fourth divided sound signal to the predetermined volume based on the instruction from the posture estimation part 216C. The fourth volume control part 210 outputs the fourth divided sound signal with set volume to the mixing part 211.

On the other hand, in a case where it is determined that there is no person who is feeling drowsy at the first position 111 to the third position 113 (NO in Step S107), in Step S109, the posture estimation part 216C determines volume of the fourth divided sound signal for suppressing drowsiness to be zero. The posture estimation part 216C sends an instruction to the fourth volume control part 210 indicating the volume of the fourth divided sound signal determined to be zero. The fourth volume control part 210 sets volume of the fourth divided sound signal to zero based on the instruction from the posture estimation part 216C. The fourth volume control part 210 outputs the fourth divided sound signal with set volume to the mixing part 211.

Next, in Step S110, the mixing part 211 outputs a synthesized sound signal obtained by synthesizing the first divided sound signal to the fourth divided sound signal with set volume to the amplifier 3. The amplifier 3 amplifies the synthesized sound signal and outputs the amplified synthesized sound signal to the loudspeaker 4. The loudspeaker 4 converts the synthesized sound signal into a synthesized sound, and emits, into the room 100, a synthesized sound obtained by synthesizing the first divided sound to the fourth divided sound to which the first volume control part 207 to the fourth volume control part 210 set respective volumes.

By the above, when the person at the first position 111 is sitting, the first divided sound with a predetermined volume is output from the loudspeaker 4, and when the person at the first position 111 is standing, the first divided sound is not output from the loudspeaker 4. Further, when the person at the second position 112 is sitting, the second divided sound with a predetermined volume is output from the loudspeaker 4, and when the person at the second position 112 is standing, the second divided sound is not output from the loudspeaker 4. Further, when the person at the third position 113 is sitting, the third divided sound with a predetermined volume is output from the loudspeaker 4, and when the person at the third position 113 is standing, the third divided sound is not output from the loudspeaker 4. Further, when there is a person who is feeling drowsy at the first position 111 to the third position 113, the fourth divided sound with a predetermined volume is output from the loudspeaker 4, and when there is no person who is feeling drowsy at the first position 111 to the third position 113, the fourth divided sound is not output from the loudspeaker 4.

For example, in a case where a person sits only at the first position 111, the first divided sound indicating a harp sound is emitted from the loudspeaker 4. Further, in a case where a person is sitting at each of the first position 111 and the second position 112, the first divided sound indicating a harp sound and the second divided sound indicating a violin sound are emitted from the loudspeaker 4. Further, in a case where a person is sitting at each of the first position 111 to the third position 113, the first divided sound indicating a harp sound, the second divided sound indicating a violin sound, and the third divided sound indicating a double bass sound are emitted from the loudspeaker 4. Furthermore, in a case where a person is sitting at each of the first position 111 to the third position 113 and a person at the second position 112 is feeling drowsy, the first divided sound indicating a harp sound, the second divided sound indicating a violin sound, the third divided sound indicating a double bass sound, and the fourth divided sound indicating marimba and drum sounds are emitted from the loudspeaker 4.

As described above, when there is a person who is feeling drowsy at any of a plurality of positions, a divided sound for suppressing drowsiness is emitted, so that it is possible to provide a stimulus to the person who is feeling drowsy and cause the person to focus on a conversation.

Further, when a person is standing, no divided sound is emitted, and when a person is sitting, a divided sound is emitted, so that it is possible to prompt a participant in a conversation (meeting) to sit down.

Note that, in a case where it is determined that there is a person who is feeling drowsy at the first position 111 to the third position 113, the posture estimation part 216C may change a predetermined sound to music having a fast tempo where BPM is equal to or more than a threshold. By this, drowsiness of a person can be further suppressed.

Note that in each of the above embodiments, each component may be implemented by being configured with dedicated hardware or by execution of a software program suitable for each component. Each component may be implemented by a program execution part, such as a CPU or a processor, reading and executing a software program recorded on a recording medium such as a hard disk or a semiconductor memory. Further, a program may be executed by another independent computer system by recording and transferring the program on a recording medium or transferring the program via a network.

Some or all functions of the devices according to the embodiments of the present disclosure are implemented as Large Scale Integration (LSI) which is typically an integrated circuit. These may be individually integrated into one chip, or may be integrated into one chip so as to include some or all of these. Further, circuit integration is not limited to LSI, and may be implemented by a dedicated circuit or a general-purpose processor. A Field Programmable Gate Array (FPGA) that can be programmed after manufacturing of LSI or a reconfigurable processor in which connection and setting of circuit cells inside the LSI can be reconfigured may be used.

Further, some or all functions of the device according to the embodiments of the present disclosure may be implemented by a processor such as a CPU executing a program.

Further, the numerical figures used above are all illustrated to specifically describe the present disclosure, and the present disclosure is not limited to the illustrated numerical figures.

Order in which each step illustrated in the above flowchart is executed is exemplified for specifically describing the present disclosure, and may be any order other than the above as long as a similar effect can be obtained. Further, some of the above steps may be executed simultaneously (in parallel) with other steps.

The technique according to the present disclosure can gather a plurality of people in a predetermined space and promote a conversation of a plurality of people in the predetermined space, and is useful as a technique for reproducing sound.

1. A sound reproduction method in a computer, the sound reproduction method comprising:
acquiring information on a plurality of people in a predetermined space;
synchronizing and reproducing a plurality of divided sound signals obtained by dividing a predetermined sound; and
outputting the plurality of divided sound signals to a loudspeaker based on the information on the plurality of people, the loudspeaker emitting, to the predetermined space, a plurality of divided sounds converted from the plurality of divided sound signals.

2. The sound reproduction method according to claim 1, wherein
the information on the plurality of people includes identification result information that identifies each of the plurality of people, the sound reproduction method further comprising:
controlling volume of each of the plurality of divided sound signals according to whether or not each of the plurality of people is identified.

3. The sound reproduction method according to claim 2, wherein the control of volume includes determining volume of a divided sound signal associated with a person to be a predetermined volume in a case where the person is identified, and determining the volume of the divided sound signal associated with the person to be zero in a case where the person is not identified.

4. The sound reproduction method according to claim 1, wherein
the information on the plurality of people includes voice information indicating an average volume of voice of each of the plurality of people in a predetermined period, the sound reproduction method further comprising:
controlling volume of each of the plurality of divided sound signals according to the average volume of the voice of each of the plurality of people in the predetermined period.

5. The sound reproduction method according to claim 4, wherein the control of the volume includes determining volume of a divided sound signal associated with a person to be a predetermined volume in a case where the average volume of voice of the person is smaller than a threshold, and determining the volume of the divided sound signal associated with the person to be zero in a case where the average volume of the voice of the person is equal to or more than the threshold.

6. The sound reproduction method according to claim 1, wherein
the information on the plurality of people includes posture information on a posture of each of the plurality of people, the sound reproduction method further comprising:
controlling volume of each of the plurality of divided sound signals according to the posture of each of the plurality of people.

7. The sound reproduction method according to claim 6, wherein
the posture information indicates whether or not each of the plurality of people is standing, and
the control of the volume includes determining volume of a divided sound signal to be a predetermined volume in a case where a person is standing, and determining the volume of the divided sound signal to be zero in a case where the person is not standing.

8. The sound reproduction method according to claim 7, wherein each of the plurality of divided sound signals is associated with each of a plurality of positions at which the plurality of people are present in the predetermined space.

9. The sound reproduction method according to claim 6, wherein
the posture information indicates whether or not each of the plurality of people is sitting at each of a plurality of positions in the predetermined space, and indicates whether or not at least one of the plurality of people is in a posture of feeling drowsy, and
the control of the volume includes determining volume of a divided sound signal associated with a position at which a person is sitting to be a predetermined volume in a case where the person is sitting, determining the volume of the divided sound signal associated with a position at which the person is not sitting to be zero in a case where the person is not sitting, determining, in a case where at least one of the plurality of people is in a posture of feeling drowsy, volume of a different divided sound signal for suppressing the drowsiness different from the plurality of divided sound signals associated with each of the plurality of positions to be a predetermined volume, and determining the volume of the different divided sound signal to be zero in a case where all of the plurality of people are not in a posture of feeling drowsy.

10. The sound reproduction method according to claim 1, wherein the predetermined sound is divided according to frequency.

11. The sound reproduction method according to claim 1, wherein the predetermined sound is music and is divided according to a plurality of performance parts forming the music.

12. A sound reproduction device comprising:
an acquisition part that acquires information on a plurality of people in a predetermined space;
a reproduction part that synchronizes and reproduces a plurality of divided sound signals obtained by dividing a predetermined sound; and
an output part that outputs the plurality of divided sound signals to a loudspeaker based on the information on the plurality of people, the loudspeaker emitting, to the predetermined space, a plurality of divided sounds converted from the plurality of divided sound signals.

13. A non-transitory computer readable recording medium storing a sound reproduction program that causes a computer to function to:
acquire information on a plurality of people in a predetermined space;
synchronize and reproduce a plurality of divided sound signals obtained by dividing a predetermined sound; and
output the plurality of divided sound signals to a loudspeaker based on the information on the plurality of people, the loudspeaker emitting, to the predetermined space, a plurality of divided sounds converted from the plurality of divided sound signals.
